(19) United States
(12) Patent Application Publication
(10) Pub. No.: US 2026/0310230 A1
(43) Pub. Date: Oct. 8, 2026

(54) SYSTEM FOR TRANSPORTING AT LEAST ONE OBJECT TO BE PROCESSED IN AT LEAST ONE PACKAGING MACHINE

(71) Applicant: Gerhard Schubert GmbH, Crailsheim (DE)

(72) Inventors: Manuel SCHUSTER, Crailsheim (DE); Volker HAAF, Crailsheim (DE); Ralf SCHUBERT, Crailsheim (DE)

(21) Appl. No.: 19/480,560

(22) PCT Filed: Apr. 30, 2024
(86) PCT No.: PCT/EP2024/061956

§ 371 Date: Oct. 31, 2025

(30) Foreign Application Priority Data
May 2, 2023 (DE) 10 2023 111 209.0

(51) Int. Cl. G05D 1/667; B65B 57/00; B66F 9/075; G05D 1/639; G05D 1/648; G05D 1/698; G05D 105/28; G05D 107/70

(52) U.S. Cl. CPC G05D 1/667; B65B 57/00; B66F 9/07504; G05D 1/6987; B66F 9/07572; G05D 1/642; G05D 1/648; G05D 2105/28; G05D 2107/70

(57) ABSTRACT

A system for transporting at least one object to be processed in at least one packaging machine along at least one transport path extending between at least one first region of the system and at least one second region of the system.

This application is the U.S. National Stage entry of International Application No. PCT/EP2024/061956, filed on Apr. 30, 2024, which, in turn, claims priority to DE Patent Application No. 102023111209.0, filed on May 2, 2023, both of which are hereby incorporated herein by reference in their entireties for all purposes.

The invention relates to a system for transporting at least one object to be processed, in particular packaged, in at least one packaging machine along at least one transport path extending between at least one first region of the system and at least one second region of the system.

Corresponding systems are known in the prior art in a variety of different embodiments and typically comprise a transport path extending between at least a first region of the system and at least a second region of the system. The first region of the system can be, for example, a loading region in which an object to be transported to the second region is transferred to a conveyor belt by means of a transfer device, such as a robot, onto a conveyor belt. The second region of the system can correspondingly be, for example, an unloading region in which an object transported to the second region is removed from the conveyor belt by means of a transfer device. The transport path is therefore usually formed by a conveyor belt or the like.

Corresponding systems can be configured as packaging systems comprising one or more packaging machines, each of which can be configured to perform one or more packaging tasks for packaging one or more objects. A corresponding packaging task can, within the scope of a corresponding transport of an object, include, for example, placing an article or product in primary packaging, such as a tray, and placing the primary packaging (together with the article or product arranged therein) in secondary packaging, such as a carton or box.

An object to be transported can therefore be, for example, an article to be packaged in appropriate primary or secondary packaging or a product to be packaged in appropriate primary or secondary packaging.

Although such systems enable reliable transport and packaging of the respective objects, they need to be further developed in terms of flexibility and versatility. This is due in particular to the fact that the use of such conveyor belts restricts the movement of the respective objects during transport between a respective first and second region of the system, or vice versa since not only the movement paths but also other movement parameters of the objects to be transported are defined by the conveyor direction and speed of the respective conveyor belt and cannot be changed during the transport of an object from the respective first region to the respective second region of the system—at least without the comparatively complex control intervention via transfer devices arranged along the conveyor belt.

Based on this, the invention is based on the object of providing an improved system for transporting at least one object to be packaged in at least one packaging machine along at least one transport path extending between at least one first region of the system and at least one second region of the system, in particular with regard to the flexibility and versatility of the transport options for a respective object between a first and a second region, or vice versa.

The object is achieved in particular by a system according to independent claim 1. The dependent claims relate to possible embodiments of the system according to independent claim 1.

A first aspect of the invention relates to a system for transporting at least one object to be packaged in at least one packaging machine along or within at least one transport path extending between at least a first region of the system and at least a second region of the system, or vice versa.

The system is therefore generally configured to transport at least one object to be processed, i.e., in particular packaged, in at least one packaging machine along or within at least one transport path extending between at least one first region of the system and at least one second region of the system, or vice versa. The system is therefore typically also configured for processing, i.e., in particular for packaging, objects. Processing processes can be processes directly or indirectly related to a packaging process of an article or product, i.e., for example, a packaging process, such as providing packaging, prepare processes, or a packaging process, such as sealing packaging filled with one or more articles or products, or final processes.

An object to be transported can therefore be, for example, an article or product to be packaged, which may already be packaged in primary packaging. Alternatively or in addition, an object to be transported may be, for example, packaging, such as secondary packaging, i.e., for example, a container, a tray, a box, etc. Furthermore, alternatively or in addition, an object to be transported may be, for example, a transport container.

The at least one first region of the system—in the following, reference may be made to a singular form in this context, which does not, however, exclude the possibility that the system has several first regions—may, for example, be a loading region in which an object to be transported to the at least one second region of the system can be transferred to the transport route by means of a transfer device or handling device, such as a robot. The at least one second region of the system—in the following, it is possible to refer to a singular form in this context, which does not, however, exclude the possibility that the system has several first regions-can correspondingly be, for example, an unloading region in which an object transported to the at least one second region of the system is removed from the at least one transport path by means of a transfer device or handling device, such as a robot, from the at least one transport path.

The system typically comprises one or more packaging machines and can therefore also be referred to as a packaging machine system. Each packaging machine in the system is configured to perform one or more tasks for packaging one or more objects. A corresponding task may include one, several, or all of the tasks listed below as examples and therefore not exhaustively:
providing and/or preparing at least one packaging element, such as a blank, which can be transferred into primary packaging, e.g., via an erecting process;
transferring at least one packaging element that can be transferred into a primary packaging, e.g., by means of an erecting process, into a primary packaging;
providing and/or preparing at least one packaging element, e.g., by means of an erecting process, that can be transferred into a secondary packaging, such as a blank;
transferring at least one packaging element that can be transferred into secondary packaging, e.g., by means of an erecting process, into secondary packaging;
providing at least one article or product to be packaged, in particular in at least one orientation and/or position that is required or expedient with regard to an upcoming arrangement or handling process;
arranging at least one article or product in a primary packaging, such as in a tray, in particular by means of a corresponding arrangement or handling process;
arranging at least one primary packaging (together with the article or product arranged therein) in at least one secondary packaging, such as a carton or box, in particular by means of a corresponding arrangement or handling process;
arranging at least one secondary packaging (together with the primary packaging arranged therein and the article or product arranged therein) in a desired configuration, e.g., stack-like or stack-shaped, with further secondary packagings.

A corresponding packaging machine and thus also the system can therefore comprise one or more functional units, which may also be referred to as functional modules, each of which can be configured to perform at least one corresponding task. In particular, a corresponding packaging machine or system can therefore comprise, for example, at least one of the following functional units:
at least one functional unit for providing and/or preparing at least one packaging element, such as a blank, which can be transferred into a primary packaging, e.g., via an erecting process; and/or
at least one functional unit for transferring at least one packaging element that can be transferred into a primary packaging, e.g., by means of an erecting process, into a primary packaging; and/or
at least one functional unit for providing and/or preparing at least one packaging element, such as a blank, which can be transferred into a secondary packaging, e.g., via an erecting process; and/or at least one functional unit for transferring at least one packaging element that can be transferred into a secondary packaging, e.g., by means of an erecting process, into a secondary packaging; and/or
at least one functional unit to provide at least one article or product to be packaged, in particular in at least one orientation and/or position that is required or expedient with regard to an upcoming arrangement or handling process; and/or
at least one functional unit for arranging at least one article or product in a primary packaging, such as in a tray, in particular by means of a corresponding arrangement or handling process; and/or
at least one functional unit for arranging at least one primary packaging (together with the article or product arranged therein) in at least one secondary packaging, such as in a carton or box, in particular by means of a corresponding arrangement or handling process; and/or
at least one functional unit for arranging at least one secondary packaging (together with the primary packaging arranged therein and the article or product arranged therein) in a desired configuration, e.g., stack-like or stack-shaped, with further secondary packaging.

Each functional unit may comprise a housing structure on or in which one or more functional devices are arranged or formed, which are configured to perform the function that can be performed or is to be performed by means of the respective functional unit. Corresponding functional devices can therefore be:
one or more devices for the, in particular, automatable, or automated, providing and/or preparing at least one packaging element, e.g., a blank, which can be transferred into a primary packaging, e.g., via an erecting process; and/or
one or more devices for transferring, in particular in an automatable or automated manner, at least one packaging element that can be transferred into a primary packaging, e.g., by means of an erecting process, into a primary packaging; and/or
one or more devices for providing and/or preparing, in particular in an automated or automatable manner, at least one packaging element, e.g., a blank, which can be transferred into a secondary packaging, e.g., by means of an erecting process; and/or at least one functional unit for transferring at least one packaging element that can be transferred into secondary packaging, e.g. by means of an erecting process, into secondary packaging; and/or
one or more devices for providing, in particular in an automated or automatable manner, at least one article or product to be packaged, in particular in at least one orientation and/or position that is required or expedient with regard to an upcoming arrangement or handling process; and/or
one or more devices for arranging, in particular in an automated or automatable manner, at least one article or product in a primary packaging, such as in a tray, in particular by means of a corresponding arrangement or handling process; and/or
one or more devices for arranging, in particular in an automated or automatable manner, at least one primary packaging (together with the article or product arranged therein) in at least one secondary packaging, such as a carton or box, in particular by means of a corresponding arrangement or handling process; and/or
one or more devices for arranging, in particular in an automatable or automated manner, at least one secondary packaging (together with the primary packaging arranged therein and the article or product arranged therein) in a desired configuration, e.g., stack-like or stack-shaped, with further secondary packaging.

A corresponding device for arranging at least one article or product in a primary packaging, such as in a tray, by means of a corresponding arrangement or handling process, and/or for arranging at least one primary packaging (together with the article or product arranged therein) in at least one secondary packaging by means of a corresponding arrangement or handling process, and/or for arranging at least one secondary packaging (together with the primary packaging arranged therein and the article or product arranged therein) in a desired configuration, e.g., stack-like or stack-shaped, by means of a corresponding arrangement or handling process, may (in each case) be configured as a transfer device or comprise at least one such device. A corresponding transfer device can be in particular configured as a handling device or comprise such a device, which comprises one or more robots configured to perform corresponding arrangement or handling processes, such as a pick-and-place robot.

Individual, several, or all functional units may also comprise a monitoring device that monitors their functional operation, e.g., implemented by optical monitoring sensors, such as cameras. The typically also present hardware and/or software-implemented controls of respective functional units can generate status information based on the monitoring information provided by respective monitoring devices, which describes the current and/or future operation of respective functional units. Corresponding monitoring information and/or status information can be transmitted to a central control device of the system, which is explained in more detail below, so that information about the current and/or future operation of respective functional units can be generated or is available in the central control device. In this respect, it is also conceivable that the central control device of the system is configured to generate control information for controlling the operation of individual, several or all functional units and to control the operation of individual, several or all functional units on the basis of such control information.

The housing structures of the functional units can each be accessible via at least one access opening, whereby the respective access openings are typically dimensioned such that at least one transport vehicle, which will be explained in more detail below, optionally loaded with at least one object, can enter and/or exit the housing structure. In particular, a corresponding transport vehicle can enter the housing structure in a first direction and exit the housing structure in the first direction or in a second, possibly inverse, direction; a turning area for at least one corresponding transport vehicle can therefore also be provided within the housing structure. The functions to be performed on objects in the respective functional units, i.e., in particular handling functions and processing functions, can therefore be carried out when a corresponding object is moved to or into the housing structure of the respective functional unit by means of a corresponding transport vehicle. One or more travel paths for transport vehicles may also be provided within the respective housing structures, which may extend in different spatial directions.

It may be expedient for the housing structures of individual, several, or all functional units to be provided with several access openings, whereby at least one access opening may be configured as an entry opening and at least one access opening as an exit opening; a transport vehicle can thus enter the housing structure of a functional unit via an entry opening and exit the housing structure of the functional unit via an exit opening. The respective entry and exit openings may be arranged on at least two different, in particular opposite, sides of the housing structure, so that a transport vehicle can enter the housing structure of the functional unit on a first side and exit the housing structure of the functional unit on a second side, thus passing through the respective functional unit. This can enable highly efficient processing of objects in respective functional units.

At least one closing member, such as a door, can be assigned to individual, several, or all access openings, which can be moved, for example, via at least one assigned actuator device, into an open position in which access to the respective housing structure is possible, and into a closed position in which access to the respective housing structure is not possible. The operation of a respective actuator device for moving a respective closing member into the open and/or closed position can be carried out via the control of the respective functional unit or by the central control device. Consequently, the central control device can also be configured to generate control information for controlling the operation of the respective actuator device and to transmit it to the respective functional units. The operation of respective actuator devices can be controlled in particular on the basis of orientations and/or positions of at least one transport vehicle detected by means of at least one detection device of the system described in more detail below; for example, a closing member of an access opening of a housing structure of a functional unit can be moved into an open position when it is detected that a transport vehicle is approaching or has approached the access opening of the housing structure of the functional unit.

Individual, several, or all functional units can be configured, arranged, or configured along the transport path, e.g., as functional cells. Individual, multiple, or all functional units can thus be arranged or configured adjacent to the transport path so that, for example, objects can be moved via the transport path into one or more functional units and/or objects can be moved from one or more functional units onto the transport path.

Individual, multiple, or all functional units can be configured in a standardized manner. This means in particular that individual, multiple, or all functional units can have the same connections and/or interfaces for supply media, such as electricity, air, etc., or for data. The standardized design of functional units has a positive effect on the flexibility and versatility of the system, as functional units can be easily arranged and/or oriented. In addition, the assembly of the system is simplified.

The system comprises several transport vehicles, each of which has a receiving region for receiving at least one object to be transported. A corresponding receiving region can, for example, be formed by a receiving surface, in particular a flat receiving surface, which is configured to receive at least one object to be transported, possibly only a single object to be transported. A corresponding receiving surface can, for example, be formed by an exposed wall of a housing structure of a respective transport vehicle. In particular, a corresponding receiving surface can, for example, be formed by an exposed wall of the housing structure of a respective transport vehicle, which wall forms an upper side of the respective transport vehicle. An object received by means of a respective transport vehicle can thus be freely received on the housing structure of the transport vehicle, if necessary. Receiving an object can thus be understood to mean arranging or placing the object on the housing structure of a respective transport vehicle.

The transport vehicles are each movable, in particular dependently or independently of one another, between the at least one first region of the system and the at least one second region of the system, or vice versa, in at least one translational and/or rotational degree of freedom of movement. In particular, combined movements of respective transport vehicles in at least one translational and at least one rotational degree of freedom of movement are also conceivable. The transport vehicles can therefore each be moved in freely configurable movement paths or trajectories, which may be aligned in parallel at least in sections, so that in principle an infinite number of degrees of freedom are available for the movement of the respective transport vehicles.

As mentioned, combined movements of respective transport vehicles in at least one translational and at least one rotational degree of freedom of movement are conceivable. Consequently, respective transport vehicles can change their orientation by means of rotational movements about a rotation axis, such as a vertical axis, while they are (simultaneously) moved translatorially along a translation axis by means of translational movements. This makes it possible, for example, for a respective transport vehicle to be loaded with an object in a first orientation in a loading region of the system and for the object to be unloaded from the respective transport vehicle in a second orientation of the respective transport vehicle in an unloading region of the system, wherein a transfer of the respective transport vehicle from the first orientation to the second orientation can be performed, for example, during a movement of the respective transport vehicle in the direction of the unloading region of the system.

A respective transport vehicle can, in particular, be movable in a rotational degree of freedom of movement, wherein it can rotate about a vertical axis at any location. A respective transport vehicle can therefore rotate in situ without performing a translational movement. This can be particularly advantageous when there is little space available to change the orientation of a respective transport vehicle in situ. In particular, this can be expedient, for example, in connection with loading and unloading operations when, for example, due to other transport vehicles, there is little space available to orient a respective transport vehicle relative to a transfer device or handling device. Similarly, it is possible for a respective transport vehicle to move in any spatial direction from a standing position, i.e., to start moving in any spatial direction from a standing position.

To perform such movements, the transport vehicles each comprise one or more driving devices that are configured to generate drive forces or torques that result in a movement of a respective transport vehicle in at least one translational and/or rotational degree of freedom of movement. Corresponding driving devices can, for example, be configured as an electric motor or comprise at least one such motor, whose energy supply can be provided via an electrical energy storage device, such as a rechargeable battery or a battery, a capacitor, in particular a supercapacitor, etc. Both corresponding driving devices and energy storage devices can be arranged or formed on or in a housing structure of a respective transport vehicle.

At least one driving device can be assigned a gearbox; this can be advantageous, for example, in order to be able to operate the driving device in a desired power range. A driving device can therefore be coupled directly or indirectly to a force transmission element via a gearbox. A corresponding gearbox can also be arranged or formed on or in a housing structure of a respective transport vehicle.

The movement of the transport vehicles in the respective at least one translational and/or rotational degree of freedom is based on control information which is or will be generated by a hardware and/or software-implemented central control device of the system. The central control device may comprise one or more program elements, such as algorithms, calculation models, etc., artificial intelligence or machine learning, such as artificial neural networks, to generate corresponding control information, on the basis of which the transport vehicles can be or are moved in the respective at least one translational and/or rotational degree of freedom of movement along or within the transport path or, in general, within the system.

The movement of the transport vehicles is therefore controlled centrally via a central control device of the system, which is configured to generate control information on the basis of which the transport vehicles can be moved or are moved in the respective at least one translational and/or rotational degree of freedom of movement along or within the transport path or, in general, within the system. The central control device is thus not integrated into the transport vehicles, but is spatially and physically separated from them, e.g., due to an arrangement on or in a frame structure of the system. The transport vehicles can therefore be very simply configured with regard to their own control system on the transport vehicle side, because the control information on the basis of which the transport vehicles can be moved or are moved in at least one translational and/or rotational degree of freedom of movement, in particular to move an object from the first region of the system to the second region or in the direction of the second region of the system, or vice versa, is generated by the central control device of the system and, as explained below, transmitted to the transport vehicles. It is therefore not required for the control system of a respective transport vehicle to generate corresponding control information on the basis of which the respective transport vehicle is moved in at least one translational and/or rotational degree of freedom of movement in order to move an object by means of the respective transport vehicle from the first region of the system to or in the direction of the second region of the system, or vice versa. In particular, the respective control of the respective transport vehicles, for example with regard to their hardware and/or software configuration, i.e. in particular their computing and/or storage capacity, can be kept comparatively simple, which also has a positive effect on the manufacturing costs of the transport vehicles.

The system further comprises at least one loading device assigned to the at least one first region of the system, which is configured for the at least partially automated loading of an object to be transported onto a respective receiving region of a transport vehicle. The loading device can be formed by or comprise a corresponding transfer device or handling device mentioned above, e.g., a robot. Movements of respective transport vehicles into the first region in order to be loaded there with an object to be transported are typically also controlled by the central control device; consequently, the central control device is in particular configured to generate control information on the basis of which a respective transport vehicle is moved into the first region of the system. The central control device may also be configured to generate control information on the basis of which a respective transport vehicle moves into a specific orientation in the first region of the system, e.g., relative to a transfer or handling device located there, for example, to enable or facilitate a loading process. Movements of a respective transport vehicle within the first region of the system, for example in order to assume a suitable loading orientation and/or position, therefore typically take place on the basis of control information generated by the control device.

The system further comprises at least one unloading device assigned to the at least one second region of the system, which is configured for the at least partially automated unloading of an object to be transported from a respective receiving region of a transport vehicle. The unloading device can be formed by or comprise a corresponding transfer device or handling device mentioned above, e.g., a robot. Movements of respective transport vehicles into the second region for unloading are typically also controlled by the central control device; thus, the central control device is specifically configured to generate control information on the basis of which a respective transport vehicle is moved into the second region of the system. The central control device may also be configured to generate control information on the basis of which a respective transport vehicle moves into a specific orientation in the second region of the system, e.g., relative to a transfer or handling device located there, for example, to enable or facilitate an unloading process. Movements of a respective transport vehicle within the second region of the system, for example in order to assume a suitable unloading orientation and/or position, are therefore typically performed on the basis of control information generated by the control device.

Finally, the system comprises a corresponding central control device which is configured at least to generate control information for controlling the movements of the transport vehicles between the at least one first region of the system and the at least one second region of the system, or vice versa. As mentioned, the central control device can be implemented in terms of hardware and/or software and thus generally enables computer-implemented generation of corresponding control information and thus computer-implemented simultaneous or at least synchronized control of movements of individual, several or all transport vehicles of the system in respective translational and/or rotational degrees of freedom of movement, in particular in order to move objects to be transported from the first region of the system to the second region of the system, or vice versa. The generation of corresponding control information and, in particular, the control of the movements of the transport vehicles based on this information can take place in real time.

The system therefore does not require a conveyor belt to implement a transport path; rather, the conveyor belt is replaced by the transport vehicles. Since the transport vehicles can generally be moved independently or in dependence on each other in their respective degrees of freedom of translational and/or rotational movement, and due to the fact that the movements of the transport vehicles are controlled centrally by the central control device of the system, a very high degree of flexibility and versatility is possible, for example with regard to the planning, implementation, and control of transport processes, resulting in an improved system. The absence of a conveyor belt also enables completely new system configurations, as the individual components of the system, such as corresponding functional units, can now be positioned as desired, since they can be reached in any case via corresponding transport vehicles.

The system typically comprises a first data transmission device assigned to the central control device, e.g., formed by or comprising at least one data transmission antenna, which is configured to transmit at least corresponding control information to the respective transport vehicles via a data connection, in particular a wireless data connection. The first data transmission device can also be configured to receive data, e.g., to receive data sent by the respective transport vehicles, provided that the transport vehicles are configured for this purpose. In order to be able to receive the control information generated by the central control device, the transport vehicles each comprise a second data transmission device, e.g. formed by or comprising at least one data transmission antenna, i.e. in particular at least one data reception device, which is configured to receive corresponding control information. A respective second data transmission device may also be configured to transmit data to the first data transmission device. To implement a corresponding data connection between the first data transmission device and the respective second data transmission devices on the transport vehicles, and thus at least to implement the transmission of corresponding control information from the central control device to the respective transport vehicles, one or more standards or protocols for data transmission, in particular wireless data transmission, can be used. Possible standards or protocols include, for example, WLAN standards such as IEEE 802.11 standards or mobile communications standards such as 5G. The data connection or data transmission can be encrypted using suitable encryption mechanisms, which may include principles of blockchain technology, in order to prevent unwanted interference or interactions.

The first data transmission device can be configured to form a separate plant-side communication network via which data can be transmitted to a communication partner, in particular a respective transport vehicle, within the system or within a component of the system, in particular within a rack structure of the system. The system can thus have its own data transmission structure by forming its own plant-side communication network, which can in particular be a wireless network, which, in particular because it is separate from other communication networks that may be present in a factory environment, enables a secure(r) data connection between the central control device and respective transport vehicles, which in turn can have a positive effect on the control of the movements of the transport vehicles in respective degrees of freedom of movement, as explained, which is carried out or implemented by the central control device.

The central control device can be configured to generate movement paths or trajectories that can be assigned or are assigned to a respective transport vehicle. The control information that can be generated or is generated by the central control device can therefore contain, in particular, corresponding movement paths or trajectories. The respective movement paths can in principle be arranged in any path geometry, in particular linear or line-shaped, in one or more, in particular vertical, spatial planes, typically extending between the first and second regions of the system. Linear or curved path geometries can, for example, comprise one or more straight path geometry sections or one or more curved path geometry sections of equal or unequal length, so that the corresponding path geometries can be both geometrically defined and geometrically undefined shapes. At least two corresponding path geometry sections may, for example, be oriented at an angle to each other.

The respective movement paths or trajectories can therefore include or be defined by, in particular, the starting and ending points, i.e., in particular the starting and ending coordinates, of a movement to be performed by a respective transport vehicle, in particular along the transport path or within the transport path. Corresponding starting points or coordinates may, for example, be located in or in a first region of the system, and corresponding end points or coordinates may, for example, be located in or in a second region of the system.

In addition, respective movement paths or trajectories may include one or more intermediate points or coordinates located between respective starting and end points or starting and end coordinates, so that a respective movement path or trajectory can be described, for example, by corresponding starting, intermediate, and end points or coordinates. Corresponding intermediate points or coordinates can, for example, be assigned to corresponding functional units, so that at least one transport vehicle is moved within the scope of a movement, e.g., from the first region to the second region of the system, e.g., into at least one functional unit in which, for example, at least one of the tasks described above is performed.

Alternatively, or in addition, respective movement paths or trajectories can contain one or more movement vectors arranged between respective start and end points or start and end coordinates, so that a respective movement path or trajectory can be described, for example, by corresponding start and end points or coordinates and corresponding movement vectors. Corresponding motion vectors can also be assigned to corresponding functional units, for example, so that at least one transport vehicle is moved within the scope of a movement, e.g., from the first region to the second region of the system, e.g., into at least one functional unit in which, for example, at least one of the tasks described above is performed.

The central control device can therefore generally be configured to generate at least two movement paths or trajectories that can be assigned or are assigned to transport vehicles, which movement paths or trajectories are identical or different. There is therefore a high degree of flexibility and versatility with regard to the planning, implementation, and control of transport processes, since, apart from avoiding collisions between the transport vehicles, there are basically no restrictions with regard to the generation of corresponding movement paths or trajectories. The central control device is therefore configured to coordinate the movements of at least two transport vehicles with the same or different movement paths or trajectories, i.e., in particular by means of appropriate synchronization, to control them in such a way that there is no risk of collision between the transport vehicles. In addition, one or more parameters, such as the load status of a respective transport vehicle with an object, the type of object, etc., can be taken into account.

The central control device can thus be configured to generate first movement paths or trajectories that can be assigned to or are assigned to a first transport vehicle, and to generate further movement paths or trajectories that can be assigned to or are assigned to at least one further transport vehicle. The respective first and further movement paths or trajectories may intersect or not intersect at at least one intersection point; if respective first and further movement paths or trajectories intersect at at least one intersection point, the central control device is configured to coordinate and/or prioritize the movements of the respective transport vehicles, i.e., in particular by means of appropriate synchronization, to control them in terms of time in such a way that there is no risk of collision between the respective transport vehicles.

In this respect, the central control device may also be configured to assign different priorities to at least two transport vehicles. In this way, it may be possible, for example, to easily control which transport vehicle has priority in certain situations, such as a situation at a corresponding intersection of at least two movement paths or trajectories.

The central control device can also be configured to generate movement paths or trajectories assigned to at least one transport vehicle group comprising at least two transport vehicles. Consequently, at least two transport vehicles can be combined into a corresponding transport vehicle group, whose movement is based on a common movement path or trajectory. The possibility of combining several transport vehicles into a corresponding transport vehicle group and controlling their movement on the basis of a movement path or trajectory can, if necessary, reduce the computational effort required to control the movements of several transport vehicles, as one movement path or trajectory can apply to several transport vehicles. In particular, several transport vehicles can move uniformly, e.g., in the direction of the second region of the system, on the basis of a corresponding movement path or trajectory, e.g., in a parallel arrangement or in an arrangement offset from each other in at least one spatial axis.

The central control device can also be configured to generate corresponding movement paths or trajectories based on at least one transport criterion relating to the transport of an object by means of a respective transport vehicle and/or at least one object criterion relating to an object to be transported. The central control device can therefore be configured to take into account at least one transport criterion relating to the transport of an object by means of a respective transport vehicle and/or at least one object criterion relating to an object to be transported when generating corresponding movement paths or trajectories.

A corresponding transport criterion can be or include, for example, at least one of the following criteria: a safety criterion relating to the safety of the transport process, e.g., with regard to a collision and/or an undesirable loss of a picked-up object, a speed criterion relating to the speed of the transport process, or an efficiency criterion relating to the efficiency of the transport process, e.g. with regard to the energy consumption of a respective transport vehicle during the transport process, an efficiency criterion relating to the wear and tear of a respective transport vehicle during the transport process.

A corresponding object criterion may, for example, comprise at least one of the following criteria: a type criterion relating to the type of object to be transported, a dimension and/or shape criterion relating to the dimensions and/or shape of the object to be transported, a mass criterion relating to the mass of the object to be transported.

The central control device may also be configured to change at least one movement path or trajectory originally assigned to at least one transport vehicle. Control information generated by the central control information and transmitted to the respective transport vehicle may therefore contain corresponding changes to the movement paths or trajectories originally assigned to the at least respective transport vehicle and thus updated movement paths or trajectories for the respective transport vehicle. A corresponding change or update to a movement path or trajectory originally assigned to a transport vehicle may be required or expedient, for example, if, due to events or the cessation of events.—which may be detected by at least one of the detection devices of the system that can be assigned or allocated to the central control device—an originally assigned movement path or trajectory within the transport path proves to be no longer executable or expedient. In particular, a corresponding change or update to a movement path or trajectory originally assigned to a transport vehicle may be required or expedient, for example, if a (potential) obstacle, such as dirt, a lost object, a defective transport vehicle, etc., is detected on the movement path or trajectory; the modified or updated movement path or trajectory then allows the obstacle to be bypassed, for example. Similarly, a corresponding change or update to a movement path or trajectory originally assigned to a transport vehicle may be required or expedient if, for example, due to the removal of an obstacle, such as dirt, e.g. due to the removal of dirt by a cleaning vehicle described in more detail below, a shorter route and thus, for example, the possibility of more efficient or faster transport of an object; the changed or updated movement path or trajectory then enables, for example, a shorter transport and thus typically reduced energy consumption.

Similarly, the central control device can also be configured to change or update a priority originally assigned to a particular transport vehicle. The priority of a transport vehicle can, in particular during movement toward the second region of the system, be changed, for example, from an originally low value to a higher value, or vice versa; in this way, situations can be taken into account in which there is a changed demand for an object transported by means of a respective transport vehicle in the second region of the system. If the demand for a particular object decreases, the priority of the respective transport vehicle can also be reduced, and vice versa.

However, other operating modes of the transport vehicles, such as a buffer mode, can also be implemented via correspondingly modified movement paths or trajectories or prioritizations. If, for example, it becomes apparent that unloading processes are delayed in an unloading region—which can in turn be detected by at least one of the system's detection devices that can be assigned or assigned to the central control device—the movement path or trajectory or prioritization of at least one transport vehicle loaded with an object can be changed so that it is not moved in the direction of the unloading region, but rather, for example, to a buffer storage area of the system and/or to a parking area of the system. It is also conceivable that, in the event of corresponding delays in the unloading region of a first packaging machine, at least one transport vehicle loaded with an object is moved to an unloading region of another packaging machine of the system on the basis of a correspondingly changed movement path or trajectory or prioritization.

At this point, it should therefore be noted in general that at least one transport vehicle can also be configured to be moved within the system from a first packaging machine to at least one further packaging machine. The central control device can therefore also be configured to generate movement paths or trajectories extending between at least two packaging machines of the system for at least one transport vehicle and to transmit these to the at least one transport vehicle so that it can be moved between at least two packaging machines. This also creates the possibility of dynamically changing the number of transport vehicles available in a respective packaging machine for transporting objects, as transport vehicles can be removed from a packaging machine in which, for example, too many transport vehicles are available with regard to a task or packaging task, and can be moved to one or more other packaging machines in which additional transport vehicles would be required or expedient with regard to a task or packaging task. Consequently, the principle described herein enables dynamic and efficient control options for the operation of a system with multiple packaging machines.

The same may apply, for example, to functional units; the central control device may therefore be configured to generate movement paths or trajectories extending between at least two functional units of a packaging machine or between at least two functional units of several packaging machines for at least one transport vehicle and to transmit them to the at least one transport vehicle so that it can be moved between at least two functional units of a packaging machine or between at least two functional units of several packaging machines.

In addition to the possibility of generating movement paths or trajectories and the possibility of changing or updating corresponding movement paths or trajectories, the central control device can also be used to control at least one movement parameter of at least one transport vehicle, in particular a positive or negative acceleration, a speed, or at least one upper and/or lower threshold value of at least one corresponding movement parameter. The central control device can therefore be configured to control at least one movement parameter of at least one transport vehicle, in particular positive or negative acceleration, speed, or at least one upper and/or lower threshold value of at least one corresponding movement parameter. The central control device can therefore also be configured to generate and control movement profiles of at least one transport vehicle.

The central control device can in particular be configured to take into account location and/or time information and/or information derived therefrom, such as current and/or future position information, of a respective transport vehicle when generating corresponding movement profiles. Corresponding movement profiles of a respective transport vehicle can thus contain, for example, location-and/or time-dependent variable movement parameters of at least one respective transport vehicle, so that the complete movement sequence of a respective transport vehicle can be controlled via the central control device.

When generating corresponding movement profiles, the central control device can thus be configured to take one or more criteria into account. Alternatively or in addition to corresponding location and/or time criteria, corresponding criteria may include, for example, the load status of a respective transport vehicle, the energy consumption of a respective transport vehicle, the charge status of at least one electrical energy storage device of a respective transport vehicle, the condition of a ground, such as a roadway on which a respective transport vehicle is moving, etc.

The central control device can also be configured to assign specific movement paths or trajectories and/or specific movement parameters to at least one transport vehicle for specific regions within the system. Consequently, the central control device can also be configured to assign movement profiles for specific areas within the system to a respective transport vehicle, so that a transport vehicle can be moved in a first region of the system, for example, at a different speed, in particular a minimum or maximum speed, than in a second region of the system. The same applies to other movement parameters of the respective transport vehicle.

Corresponding regions of the system can be regions within a packaging machine, so that a first region can be, for example, a first section or part of a transport path, and a second region can be, for example, a second section or part of the transport path within a packaging machine. Alternatively or in addition, corresponding regions of the system can each be, for example, an (entire) transport path within a specific packaging machine, so that a first region can be, for example, a transport path within a first packaging machine and a second region can be a transport path within a second packaging machine.

The central control device can also be configured to generate control information on the basis of which at least two transport vehicles are moved into a specific formation, in particular into a specific spatial alignment and/or position relative to each other, or assume such a specific formation during movement along the transport path. By forming corresponding formations, enlarged loading or unloading areas can be created as required, since the loading or unloading areas of the transport vehicles arranged in a corresponding formation can be added together to form a resulting loading or unloading area. The transport vehicles can therefore be arranged adjacent to each other, e.g., in rows and/or columns, on the basis of corresponding control information generated by the central control device, in such a way that their respective loading or unloading areas can be added together or combined to form a resulting loading or unloading area. By determining the number and arrangement or orientation of respective transport vehicles placed in a corresponding formation, individually dimensioned loading or unloading areas can be implemented, which also enables the transport of objects that could not be transported with a single transport vehicle, e.g., due to their dimensions.

The control information that can be generated or is generated by the central control device, on the basis of which at least two transport vehicles can be placed in a specific formation, in particular in a specific spatial orientation and/or position relative to each other, or to assume such a specific formation during movement along the transport path, can therefore be generated on the basis of at least one transport criterion relating to the transport of an object by means of the respective transport vehicle and/or at least one object criterion relating to at least one object to be transported. The central control device can therefore be configured to generate corresponding control information based on at least one transport criterion relating to the transport of an object by means of the respective transport vehicle and/or at least one object criterion relating to at least one object to be transported.

A corresponding transport criterion may, for example, be or comprise at least one of the following criteria: a safety criterion relating to the safety of the transport operation, an efficiency criterion relating to the efficiency of the transport operation.

A corresponding object criterion may, for example, be or comprise at least one of the following criteria: type of object to be transported, dimensions and/or shape of the object to be transported, mass of the object to be transported.

As mentioned, a respective transport vehicle may have a housing structure. A corresponding receiving region, which, as also mentioned, may in particular be a support surface, especially a flat one, is typically arranged or formed on or in the housing structure.

A corresponding receiving region of at least one transport vehicle can, for example, be assigned at least one securing device, by means of which an object to be transported can be secured to the receiving region and thus generally to the transport vehicle as required. A corresponding securing device can be actively designed, i.e., it can be transferred to an active securing state. A corresponding actively configured securing device may, for example, comprise at least one securing element that can be transferred into a securing state, in which it securely engages with a respective object, and into a non-securing state, in which it does not securely engage with a respective object. A corresponding securing element may be configured as a shape-fit or force-fit element or may comprise at least one such element. A corresponding actively executed securing device can, for example, also be configured as a vacuum device which secures an object in a securing state by applying a vacuum. A corresponding passively executed securing device can, for example, be configured with an adhesion-enhancing surface or surface structure, e.g., in the shape of a rubber coating, of the receiving region.

At least one of the following components of the respective transport vehicle may be arranged or formed on or in a respective housing structure: at least one driving device for generating drive forces or torques, at least one energy storage device that can be assigned or is assigned to the at least one driving device, at least one force transmission element, such as a wheel, a roller, etc., via which drive forces or torques generated by means of the driving device can be transmitted to a ground, a corresponding second data transmission device, a control system (on-board control), a detection device, such as a camera, for detecting a ground or ground structure on which the respective transport vehicle can be moved or driven. A corresponding force transmission element can therefore be, in particular, a mechanical force transmission element since mechanical forces can be transmitted to a ground via this element. Corresponding components can be arranged or formed, in particular, at least in sections, or completely, within a receiving space defined by one or more walls of the housing structure, so that they are protected from external influences. The receiving space may have receiving compartments formed by one or more wall sections, each receiving compartment being configured to receive at least one component of the respective transport vehicle. The dimensions of a respective receiving compartment can thus be selected, for example, with regard to the dimensions of at least one component of the respective transport vehicle, so that at least one component can be accommodated in the respective receiving compartment, if necessary with a precise fit, in a manner that prevents it from being lost.

Corresponding driving devices and force transmission elements can form drive units of a respective transport vehicle. It is expedient if, when several separate driving devices are formed, at least one driving device is assigned to each force transmission element, so that each force transmission element is subjected to force or torque independently of other force transmission elements and is thus driven. In other words, the operation of each drive unit can be controlled individually, so that each force transmission element of a drive unit can be set in motion or locked in a specific direction of movement independently of the force transmission elements of other drive units of the respective transport vehicle, making it possible, for example, to rotate a respective transport vehicle, as described, in place and thus, for example, orient it in a desired manner without performing a translation.

In a particular embodiment, a respective transport vehicle may comprise three corresponding drive units in a 120° offset arrangement. A respective transport vehicle may thus comprise three drive axes arranged at 120° to each other, each of which has at least one force transmission element, such as a wheel, a roller, etc. This not only enables the transport vehicle to rest stably on a ground, i.e., in particular, to be secured against tipping over, but also allows the described rotational movements of the transport vehicle to be performed on the spot.

In a particular embodiment, a corresponding force transmission element can be configured as an omnidirectional wheel (omni wheel) or comprise at least one such wheel. A corresponding omnidirectional wheel comprises at least one base structure that can be driven to rotate about a rotational axis and has a running surface formed by several rollers or rollers whose rotational axes are arranged at right angles to the rotational axis of the base structure. An expedient configuration with several corresponding basic structures is advantageous, the rollers or rollers of which are arranged offset from each other in the circumferential direction so that one roller or roller always contacts a ground. The rolling and wear properties of the omnidirectional wheel can be improved in this way.

Corresponding control commands for controlling the operation of respective drive units of a respective transport vehicle may also be included in the control information transmitted to the respective transport vehicle; the central control device may therefore also be configured to control the operation of respective drive units of respective transport vehicles. However, it is also conceivable that a control system of a respective transport vehicle generates corresponding control commands for controlling the operation of respective drive units on the basis of respective control information transmitted by the central control device.

The housing structures of the transport vehicles can each have a polygonal, in particular quadrangular, pentagonal, or hexagonal basic shape. A corresponding polygonal basic shape can enable or simplify a (directly) adjacent arrangement of at least two transport vehicles, forming a corresponding formation which forms a common, in particular closed, receiving surface for at least one object.

The housing structures of the transport vehicles can be configured as single-piece or multi-piece constructions. In particular, a multi-piece configuration of a housing structure with a lower part and an upper part mounted so as to be rotatable relative to it about a vertical axis is conceivable, wherein the upper part has a corresponding receiving region, which, as also mentioned, can be in particular a flat support surface. This can be expedient in order to align an object located on the receiving region in the desired manner, independently of the orientation of the lower part, by means of corresponding rotary movements of the upper part relative to the lower part, or to maintain a desired alignment independently of the orientation of the lower part. In order to achieve corresponding rotational movements of the upper part, at least one driving device, e.g., in the form of an electric motor, may be assigned to it.

At least two transport vehicles may have at least one coupling interface, for example a magnetic or mechanical coupling interface, which coupling interfaces are configured to couple at least two transport vehicles together to form a transport vehicle arrangement, in particular one that can be detached as required. Consequently, at least two transport vehicles can be coupled to each other to form a transport vehicle arrangement, in particular detachable as required. This can be expedient, for example, in order to move several transport vehicles together. In particular, several transport vehicles coupled to form a transport vehicle arrangement can be moved together, for example, from a first packaging machine to a second packaging machine of the system. It may also be expedient to move respective transport vehicle arrangements into a cleaning device, a maintenance device, or a loading device of the system, etc., which are described in more detail below.

Due to the coupling of the transport vehicles, it is fundamentally possible to generate control information for at least one transport vehicle serving as a push and/or pull vehicle for corresponding transport vehicle arrangements, since the remaining transport vehicles of the respective transport vehicle arrangement follow the movement path or trajectory of the at least one push or pull vehicle. The central control device can therefore be configured to generate control information on the basis of which at least one transport vehicle of a corresponding transport vehicle arrangement is defined as a push and/or pull vehicle of the transport vehicle arrangement and at least one transport vehicle of the transport vehicle arrangement is defined as a non-push and/or pull vehicle, whereby the at least one transport vehicle defined as a push or pull vehicle generates forces or moments, by means of which the at least one transport vehicle defined as a non-pushing and/or non-pulling vehicle can be moved or is moved, in particular by pushing or pulling forces generated by the pushing or pulling vehicle.

A corresponding coupling interface of at least one first transport vehicle may comprise at least one coupling member that can be transferred into a coupling state and into a non-coupled state. The at least one coupling member can interact in the coupling state by forming a coupling with the coupling interface of at least one other transport vehicle, and in the non-coupled state by not forming a coupling with the coupling interface of at least one other transport vehicle. The central control device may be configured to generate coupling information on the basis of which the at least one coupling member of a respective transport vehicle can be transferred to the coupling state and/or to the non-coupled state. In this respect, an actuator device may be assigned to the at least one coupling member of the respective transport vehicle, which transfers the at least one coupling member into the coupling state and/or into the non-coupled state on the basis of corresponding coupling information.

The configuration of the respective transport vehicles is, for example in order to keep manufacturing costs low, generally comparatively simple, as they are only configured to transport an object, as described, along at least one transport path extending between at least a first region of the system and at least a second region of the system. A large number of the transport vehicles of the system can therefore have a minimum configuration with at least one corresponding receiving region, at least one drive unit, at least one second data transmission device, and at least one control system, which, as mentioned, can be arranged or formed on or in a corresponding housing structure.

However, it is conceivable that the system may have transport vehicles that are configured differently or additionally with regard to their function:

For example, it is conceivable that the system has at least one transport vehicle which comprises at least one effector unit, i.e., for example, a gripping or suction unit, which is configured to grip an object located on the transport path and/or a potential obstacle at least in sections and thus remove it from the transport path. A corresponding effector unit can be configured to attach an object located on the transport path and/or a potential obstacle to the respective transport vehicle, e.g., by gripping, suction, etc., and thus move it to a region outside the transport path. This ensures efficient operation of the system because control interventions by the central control device to prevent collisions between transport vehicles and objects and/or potential obstacles located on the transport path can be reduced or avoided. The operation of a correspondingly configured transport vehicle is typically also controlled on the basis of control information generated by the central control device.

It is also conceivable that at least one transport vehicle comprises at least one cleaning unit, i.e., for example, a brush, blowing, suction, or rinsing unit, which is configured to clean a driving surface intended for the transport vehicle. A corresponding cleaning unit can clean a driving surface, for example, by mechanical cleaning using a brush unit, by blowing away or sucking up contaminants using a blowing or suction unit, or by applying a rinsing or cleaning fluid using a rinsing unit. The operation of a correspondingly configured transport vehicle is typically also controlled on the basis of control information generated by the central control device.

The system may further comprise at least one transfer vehicle which is configured to accommodate several transport vehicles in a designated receiving region and to move them collectively within the system. This provides an efficient means of moving several transport vehicles within the system, as they can be moved indirectly via the at least one transfer vehicle, so that the respective transport vehicles do not consume any energy for corresponding transfers within the system.

It was mentioned above that at least two transport vehicles can be brought into a formation to create a resulting loading or unloading area. A similar approach to this can be taken if at least one transport vehicle has at least one extension structure that extends its receiving region, in particular a receiving surface, which can be arranged or is arranged on the at least one transport vehicle via an interface, e.g., a mechanical interface. By means of a corresponding extension structure, it is therefore possible to extend the receiving region of a transport vehicle even without forming a corresponding formation of at least two transport vehicles. The extension structure can, in particular, be arranged or formed on the outer circumference of the housing structure of the respective transport vehicle and form an enlarged receiving surface with at least one extension surface element arranged in alignment with the receiving surface of the respective transport vehicle.

A corresponding extension structure can therefore have one or more extension surface elements which are movable relative to each other in at least one degree of freedom of movement, so that the extension structure has a first configuration with a first surface area and at least one further configuration different from the first configuration, in which it has a surface area different from the first surface area,, i.e., in particular, an enlarged or reduced further surface area.

It was mentioned at the outset that the system may comprise several packaging machines. In a corresponding configuration with a first packaging machine and at least one further packaging machine, the central control device can be configured to generate control information on the basis of which at least one transport vehicle can be moved from the first packaging machine to the at least one further packaging machine, or vice versa.

It was also mentioned that transport vehicles can be moved between at least two packaging machines of the system. In this context, it may be expedient, for example with regard to safety and control aspects, for a first packaging machine to be connected to at least one further packaging machine via at least one connecting structure, in particular a tunnel-like or tunnel-shaped connecting structure. The respective transport vehicles can thus be moved between the respective packaging machines of the system by means of a corresponding connecting structure; since a corresponding connecting structure typically also limits or defines the travel path between respective packaging machines of the system, complex control of the movements of the transport vehicles by the central control device is not required, as the transport vehicles can be guided along or through the connecting structure, e.g., by its walls, as they move.

A further advantage of using such transport vehicles is that they can be moved not (only) on flat grounds, but also on grounds that are inclined or curved relative to a horizontal reference plane. Consequently, the transport path or at least one transport path of the system can be arranged within a transport plane that is inclined and/or curved at least in sections. In principle, however, the transport path or at least one transport path of the system is (essentially) oriented parallel to a horizontally oriented ground, such as the floor of a hall.

This also means that the system can generally comprise several transport paths arranged in different spatial directions and/or spatial planes. In particular, a stack-like or stack-shaped arrangement of several transport paths in several spatial planes one above the other is conceivable; this can be achieved, for example, by means of a rack structure which enables a stack-like or stack-shaped arrangement of several transport paths in several spatial planes one above the other. Corresponding transport paths and the resulting transport path levels can be connected to each other, for example, via ramp-like or ramp-shaped connecting sections, so that a transport vehicle can be moved, for example, from a lower transport path via a corresponding connecting section to an upper transport path, or vice versa. One or more lifting devices, such as elevators, may also be provided, via which one or more transport vehicles can be moved to respective transport route levels. The operation of the respective lifting devices can also be controlled on the basis of control information generated by the central control device.

The system may comprise at least one guide device having one or more guide members. The guide device is configured in particular to implement a guided movement of at least one transport vehicle along at least one guide member. Guided movements of respective transport vehicles can reduce the control effort required to implement movements of respective transport vehicles, as at least one movement path or trajectory of corresponding transport vehicles is at least partially predefined by corresponding guide members. A corresponding guide member can, for example, be formed by or comprise a surface element arranged or formed on or within the system, in particular in a standing, lying, hanging, etc. position, which has or delimits a surface along which a transport vehicle is guided in a movable manner. Corresponding surface elements can have a one-or multidimensional spatial extension, so that corresponding guide members can be, for example, and thus not exclusively, wall elements, rail elements, pin elements, rod elements, grid elements, fence elements, etc.

As mentioned, the at least one first region of the system can be, for example, a loading region in which an object to be transported to the second region can be transferred to the transport path by means of a transfer device or handling device, such as a robot, and the second region of the system can correspondingly be, for example, an unloading region in which an object transported to the second region is removed from the transport path by means of a transfer device or handling device, such as a robot.

The operation of the respective transfer devices can also be controlled by the central control device. The central control device can be configured in particular to control the operation of the transfer devices on the basis of current and/or future orientations and/or positions of respective transport vehicles.

The system can accordingly comprise at least one detection device which is configured to detect current and/or future orientations and/or positions of respective transport vehicles. The at least one detection device may in particular be configured to detect the current and/or future orientation and/or position of respective transport vehicles in the at least one first region of the system and/or in the at least one second region of the system and/or to detect movements of respective transport vehicles between the at least one first region and the at least one second region, or vice versa. The at least one detection device can transmit corresponding detection information describing current and/or future orientations and/or positions of respective transport vehicles to the central control device; the central control device can thus communicate with the at least one detection device via a data connection, e.g., a wireless data connection.

The at least one detection device may, for example, be arranged or formed on or in the region of a ceiling of a rack structure of a packaging machine of the system. In this way, the at least one detection area can be arranged at a sufficient distance from the transport path in order to achieve the largest possible detection area. The detection area of the at least one detection device may, if necessary, cover the entire transport path between a first and a second region of the system. Alternatively, or additionally, it is conceivable that several detection devices are provided, whose respective detection areas together cover the entire transport path between a first and a second region of the system. It is generally expedient for the at least one detection device to be positioned above the respective transport path, as this typically increases the detection range of the respective detection device.

Corresponding detection devices may have one or more optical detection elements which, for example in the shape of one or more cameras, may be configured as optical sensors, in particular orientation and/or position sensors, or may comprise such sensors. The respective detection elements can generate detection information that describes, for example, the orientation and/or position of the respective transport vehicles in space.

The detection information generated by the respective detection elements can be evaluated by a hardware and/or software-implemented evaluation device with regard to at least one evaluation criterion. The evaluation device may be integrated into the central control device in hardware and/or software form. The evaluation device may be configured in particular if the evaluation criterion is, for example, a target orientation and/or target position of a respective transport vehicle, compare an actual orientation and/or actual position of a respective transport vehicle with a target orientation and/or target position of the respective transport vehicle in order to determine any deviations of the transport vehicle from a movement path or trajectory originally specified by the central control device. When determining a current and/or future deviation in the manner described above, the central control device can, if necessary, make corrective changes or updates to the movement path or trajectory.

It should be noted at this point that, although these should, as mentioned, be configured as simply as possible, transport vehicles may also be equipped with detection sensors, in particular optical detection sensors, such as a camera. Such detection sensors may be configured in particular to detect patterns, i.e., in particular machine-readable codes such as barcodes, QR codes, etc., arranged or formed on or in a transport path, other components of the system, such as a frame structure of the system, or other transport vehicles. This can, for example, provide additional safety by ensuring that transport vehicles do not collide.

The system may comprise at least one cleaning device, in particular configured as a cleaning station, which is configured for the cleaning, in particular automated or automatable cleaning, of at least one component of respective transport vehicles, in particular of, for example, wheel- or roller-shaped power transmission elements of respective transport vehicles. A corresponding cleaning device can be a further example of a functional unit of the system into which a respective transport vehicle can be moved on the basis of control information from the central control device. A corresponding cleaning device can therefore also be arranged, for example, adjacent to a transport path. Analogous to a car wash for motor vehicles, a corresponding cleaning device may comprise one or more cleaning units or tools, e.g., in a housing structure of the cleaning device that is accessible at least on one side at least temporarily, which enable chemical and/or physical cleaning of at least one component of a respective transport vehicle. Corresponding cleaning units or tools can also be configured as, for example, brush, blowing, suction, or rinsing units, or comprise such units.

The system can also comprise at least one maintenance device configured in particular as a maintenance station, which is configured for the maintenance, in particular automated or automatable maintenance, of at least one component of respective transport vehicles. A corresponding maintenance device can be a further example of a functional unit of the system into which a respective transport vehicle can be moved on the basis of control information from the central control device. A corresponding maintenance device can therefore also be arranged adjacent to a transport path, for example. Analogous to a workshop for motor vehicles, a corresponding maintenance device may comprise one or more maintenance units or tools, e.g., in a housing structure of the cleaning facility that is accessible at least on one side at least temporarily, which enable maintenance, i.e., in particular repair and/or replacement, of at least one component of a respective transport vehicle. Corresponding maintenance units or tools may, for example, be configured as screw units, welding units, etc., or comprise such units.

The system may also comprise at least one charging device, in particular configured as a charging station, which is configured for the, in particular contactless, charging of an electrical energy storage device of a respective transport vehicle. A corresponding charging device may be a further example of a functional unit of the system into which a respective transport vehicle can be moved on the basis of control information from the central control device. A corresponding charging device can therefore also be arranged adjacent to a transport path, for example. Analogous to a charging station for electric motor vehicles, a corresponding charging device can comprise one or more charging units or plugs, e.g., in a housing structure of the charging device that is accessible at least on one side at least temporarily. It is also conceivable that respective charging units are configured to replace and/or inductively charge a respective energy storage device; in the latter case, a respective transport vehicle can even be moved during a charging process if necessary.

In all cases, the central control device may be configured to generate control information on the basis of which at least one transport vehicle can be moved into the cleaning device and/or into the maintenance device and/or into the charging device. The central control device may also be configured to control and/or monitor the operation of respective cleaning, maintenance, and/or charging devices.

Finally, it should be noted that a respective transport vehicle is typically an unmanned ground vehicle that can be moved on a floor or ground surface. A suitable ground can be, for example, the floor of a factory hall, so that, although not excluded, it is in principle possible to form at least one corresponding transport path (directly) on the hall floor, e.g., of a factory hall, without additional racks, which can considerably simplify the construction of the system. As mentioned, a suitable ground is typically horizontally oriented.

However, a suitable ground can also be formed by one or more track elements arranged at least 10 cm, in particular at least 25 cm, and in particular at least 50 cm, above the hall floor. Suitable roadway elements can be configured as, for example, rack-like or rack-shaped roadway modules, which can be connected to each other to form a roadway for the transport vehicles. The roadway elements can each have one or more, for example, mechanical interfaces via which they can be connected to each other. Corresponding roadway elements can also be carriers for one or more data and/or supply lines, e.g., for corresponding functional units, meaning that one or more data and/or supply lines, e.g., for corresponding functional units, can be arranged or formed on or in a respective roadway element.

In principle, it is also conceivable that one, several, or all of the transport vehicles are configured as unmanned aerial vehicles, i.e., in particular as flying drones, or as watercraft, i.e., in particular as water drones. A design as a hovercraft is also conceivable in principle. It is also conceivable that at least one transport vehicle is configured as a ground vehicle and at least one other transport vehicle is configured as an air, water, or hovercraft vehicle.

A second aspect of the invention relates to a transport vehicle for a system according to the first aspect of the invention. The transport vehicle is typically relatively small in size; the maximum dimensions of the transport vehicle in the length and/or width and/or height direction do not typically exceed 50 cm, in particular 40 cm, further in particular 30 cm, further in particular 25 cm.

A third aspect of the invention relates to a method for transporting at least one object to be packaged in at least one packaging machine along or within a transport path extending between at least one first region of the system and at least one second region of the system according to the first aspect of the invention. The method comprises in particular the following steps:
loading at least one transport vehicle movable in at least one translational and/or rotational degree of freedom on the basis of control information generated by the central control device of the system with at least one object to be transported on or in a transport vehicle, on the basis of control information generated by the central control device of the system in at least one transport vehicle movable in at least one translational and/or rotational degree of freedom with at least one object to be transported at or in a first region of the system by means of a loading device or a transfer device configured as a loading device;
Controlling a movement of the transport vehicle loaded with the at least one object to be transported by means of the central control device to a second region of the system along at least one movement path or trajectory defined by the central control device; and
unloading the at least one object to be transported at or in the at least one second region of the system by means of an unloading device or a transfer device configured as an unloading device.

All embodiments in connection with the system according to the first aspect of the invention apply analogously to the transport vehicle according to the second aspect of the invention and/or to the method according to the third aspect of the invention, and vice versa.

The invention is explained again below with reference to the exemplary embodiments shown in the figures. Here,

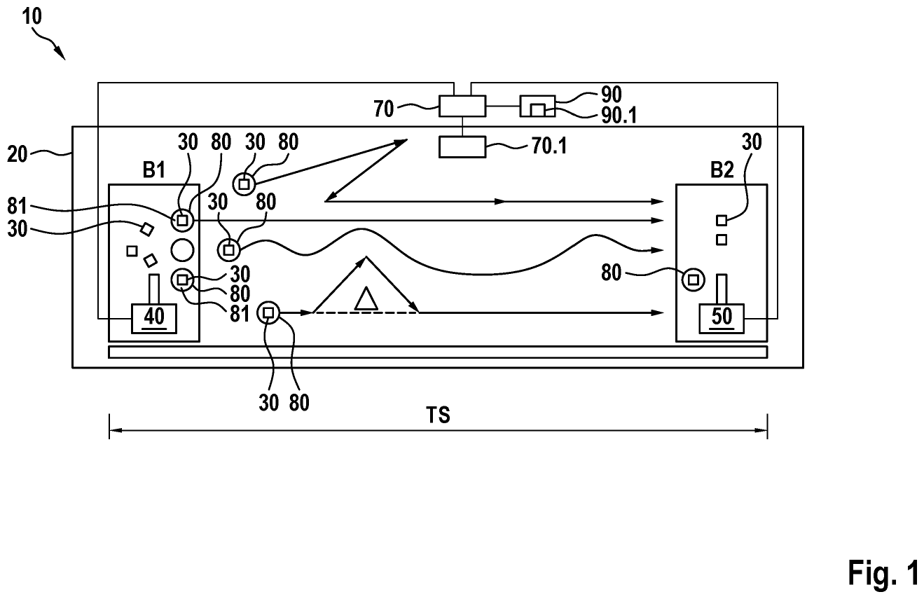

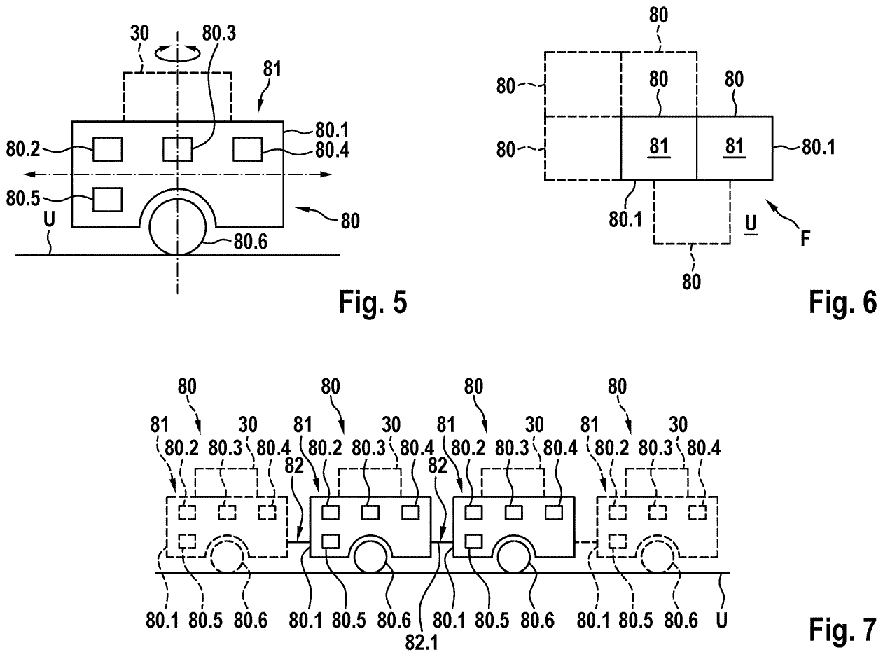

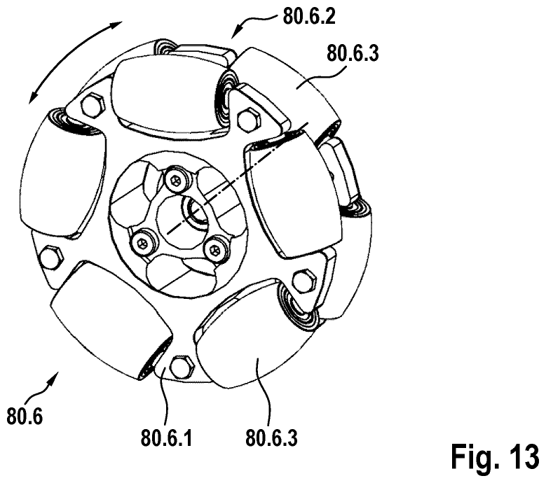

FIGS. 1-4 and 12 each show a schematic representation of a system according to an exemplary embodiment; FIGS. 5, 8, 9, and 11 each show a schematic representation of a transport vehicle according to an exemplary embodiment; FIG. 6 shows a schematic representation of a formation comprising several transport vehicles according to an exemplary embodiment; FIG. 7 shows a schematic representation of several transport vehicles coupled together to form a transport vehicle arrangement; FIG. 10 shows a schematic representation of a transfer vehicle according to an exemplary embodiment; and FIG. 13 shows a schematic representation of a force transmission element of a transport vehicle according to an exemplary embodiment.

FIG. 1 shows a schematic representation of a system 10 for transporting at least one object 30 to be packaged in at least one packaging machine 20 along or within at least one transport path TS extending between at least one first region B1 of the system 10 and at least one second region B2 of the system 10, or vice versa.

The system 10 is therefore generally configured for transporting at least one object 30, which is to be processed, i.e. in particular packaged, in at least one packaging machine 20, along or within at least one transport path TS extending between at least one first region B1 of the system 10 and at least one second region B2 of the system 10, or vice versa. The system 10 is therefore typically also configured for processing, i.e., in particular for packaging, objects 30. Corresponding processing processes may be processes directly or indirectly related to a packaging process of an article or product. i.e., for example, a packaging process, such as by providing packaging, prepare processes, or a packaging process, such as by sealing packaging filled with one or more articles or products, concluding processes.

An object 30 to be transported can therefore be, for example, an article or product to be packaged, which may already be packaged in primary packaging. Alternatively or additionally, an object 30 to be transported may, for example, be packaging, such as secondary packaging, i.e., for example, a container, a tray, a box, etc. Furthermore, as an alternative or supplement, an object 30 to be transported may, for example, be a transport container.

The at least one first region B1 can, as shown schematically in FIG. 1, be a loading region in which an object 30 to be transported to the second region B2 can be transferred to the transport path TS by means of a transfer device 40 or handling device, such as a multi-axis robot, which is also shown schematically. The at least one second region B2 can, as schematically shown in FIG. 1, correspondingly be an unloading region in which an object 30 transported into the second region B2 is removed from the transport path TS by means of a transfer device 50 or handling device, such as a multi-axis robot, which is also shown schematically.

The system 10 thus typically comprises one or more packaging machines 20 and can therefore also be referred to as a packaging machine system. Each packaging machine 20 is configured to perform one or more tasks for packaging one or more objects 30. A corresponding task may include one, several, or all of the tasks listed below as examples and therefore not exhaustively:
providing and/or preparing at least one packaging element, such as a blank, which can be transferred into primary packaging, e.g., via an erecting process;
transferring at least one packaging element that can be transferred into a primary packaging, e.g., by means of an erecting process, into a primary packaging;
providing and/or preparing at least one packaging element, e.g., by means of an erecting process, that can be transferred into a secondary packaging, such as a blank;
transferring at least one packaging element that can be transferred into secondary packaging, e.g., by means of an erecting process, into secondary packaging;
providing at least one article or product to be packaged, in particular in at least one orientation and/or position that is required or expedient with regard to an upcoming arrangement or handling process;
arranging at least one article or product in a primary packaging, such as in a tray, in particular by means of a corresponding arrangement or handling process;
arranging at least one primary packaging (together with the article or product arranged therein) in at least one secondary packaging, such as a carton or box, in particular by means of a corresponding arrangement or handling process;
arranging at least one secondary packaging (together with the primary packaging arranged therein and the article or product arranged therein) in a desired configuration, e.g., stack-like or stack-shaped, with further secondary packaging.

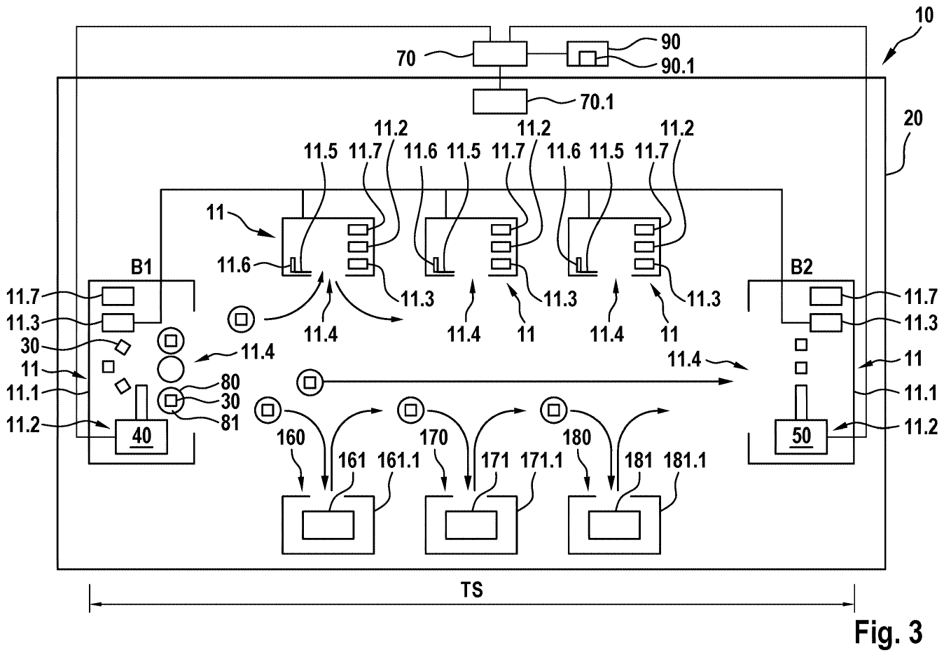

A corresponding packaging machine 20 and thus also the system 10 can therefore comprise one or more functional units 11, which may also be referred to as functional modules, see also, for example, the exemplary embodiment according to FIG. 3, which can each be configured to perform at least one corresponding task. In particular, a corresponding packaging machine 20 or the system 10 can therefore comprise, for example, at least one of the following functional units 11:
at least one functional unit for providing and/or preparing at least one packaging element, such as a blank, which can be transferred into a primary packaging, e.g., via an erecting process; and/or
at least one functional unit for transferring at least one packaging element that can be transferred into a primary packaging, e.g., by means of an erecting process, into a primary packaging; and/or
at least one functional unit for providing and/or preparing at least one packaging element, such as a blank, which can be transferred into secondary packaging, e.g., via an erecting process; and/or at least one functional unit for transferring at least one packaging element that can be transferred into a secondary packaging, e.g., by means of an erecting process, into a secondary packaging; and/or
at least one functional unit to provide at least one article or product to be packaged, in particular in at least one orientation and/or position that is required or expedient with regard to an upcoming arrangement or handling process; and/or
at least one functional unit for arranging at least one article or product in a primary packaging, such as in a tray, in particular by means of a corresponding arrangement or handling process; and/or
at least one functional unit for arranging at least one primary packaging (together with the article or product arranged therein) in at least one secondary packaging, such as in a carton or box, in particular by means of a corresponding arrangement or handling process; and/or
at least one functional unit for arranging at least one secondary packaging (together with the primary packaging arranged therein and the article or product arranged therein) in a desired configuration, e.g., stack-like or stack-shaped, with further secondary packaging.

Each functional unit 11 may comprise a housing structure 11.1 on or in which one or more functional devices 11.2 are arranged or formed, which functional devices 11.2 are configured to perform the function to be performed or executed by means of the respective functional unit 11-17. Corresponding functional devices 11.2 can therefore be, for example:
one or more devices for the, in particular, automatable, or automated, providing and/or preparing at least one packaging element, such as a blank, which can be transferred into a primary packaging, e.g., via an erecting process; and/or
one or more devices for transferring, in particular in an automated or automatable manner, at least one packaging element that can be transferred into a primary packaging, e.g., by means of an erecting process, into a primary packaging; and/or
one or more devices for providing and/or preparing, in particular in an automated or automatable manner, at least one packaging element, e.g., a blank, which can be transferred into a secondary packaging, e.g., by means of an erecting process; and/or at least one functional unit for transferring at least one packaging element that can be transferred into secondary packaging, e.g. by means of an erecting process, into secondary packaging; and/or
one or more devices for providing, in particular in an automated or automatable manner, at least one article or product to be packaged, in particular in at least one orientation and/or position that is required or expedient with regard to an upcoming arrangement or handling process; and/or
one or more devices for arranging, in particular in an automated or automatable manner, at least one article or product in a primary packaging, such as in a tray, in particular by means of a corresponding arrangement or handling process; and/or
one or more devices for arranging, in particular in an automated or automatable manner, at least one primary packaging (together with the article or product arranged therein) in at least one secondary packaging, such as a carton or box, in particular by means of a corresponding arrangement or handling process; and/or
one or more devices for arranging, in particular in an automated or automatable manner, at least one secondary packaging (together with the primary packaging arranged therein and the article or product arranged therein) in a desired configuration, e.g., stack-like or stack-shaped, with further secondary packaging.

A corresponding device for arranging at least one article or product in a primary packaging, such as in a tray, by means of a corresponding arrangement or handling process, and/or for arranging at least one primary packaging (together with the article or product arranged therein) in at least one secondary packaging by means of a corresponding arrangement or handling process, and/or for arranging at least one secondary packaging (together with the primary packaging arranged therein and the article or product arranged therein) in a desired configuration, e.g., stack-like or stack-shaped, by means of a corresponding arrangement or handling process, can (in each case) be configured as a transfer device 60 or comprise at least one such device. A corresponding transfer device 60 can be in particular configured as a handling device or comprise such a device, which comprises one or more multi-axis robots configured to perform corresponding arrangement or handling processes, such as a pick-and-place robot.

Individual, several, or all functional units 11 may also comprise a monitoring device 11.3 that monitors their functional operation, e.g., implemented by optical monitoring sensors, such as cameras. The typically also present hardware and/or software-implemented controllers 11.7 of the respective functional units 11 can generate status information based on the monitoring information supplied by the respective monitoring devices 11.3, which describes the current and/or future operation of the respective functional units 11. Corresponding monitoring information and/or status information can be transmitted to a central control device 70 of the system 10, so that information about the current and/or future operation of respective functional units 11 can be generated or is available in the central control device 70. In this respect, it is also conceivable that the central control device 70 is configured to generate control information for controlling the operation of individual, several, or all functional units 11 and controls the operation of individual, several, or all functional units 11 on the basis of such control information.

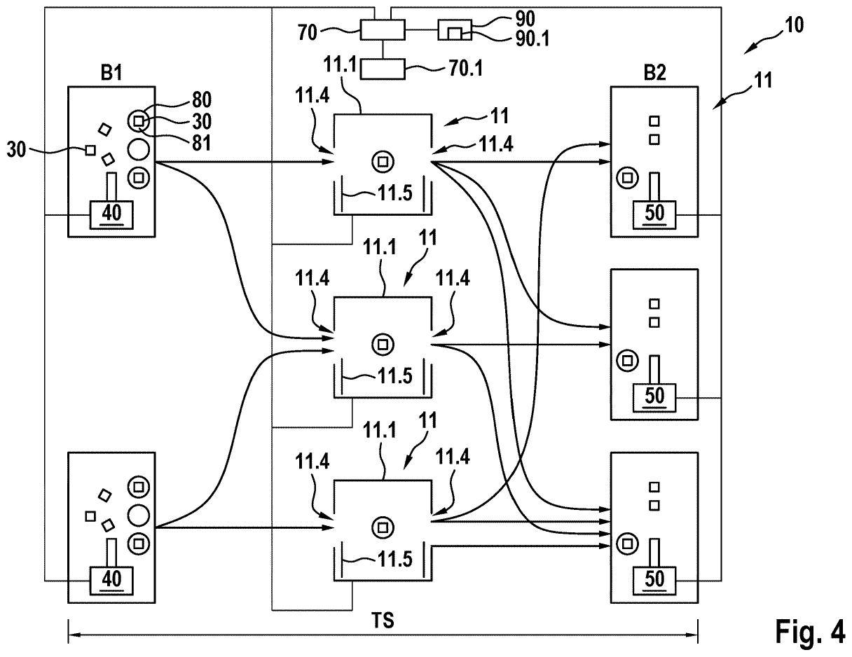

As can be seen in particular from FIGS. 3 and 4, the housing structures 11.1 of the functional units 11 can be accessible via at least one access opening 11.4, wherein the respective access openings 11.4 are typically dimensioned such that at least one transport vehicle 80, which may be loaded with at least one object 30, can enter and/or exit the housing structure 11.1. In particular, a corresponding transport vehicle 80 can enter the housing structure 11.1 in a first direction and exit the housing structure 11.1 in the first direction or in a second, possibly inverse, direction; within the housing structure 11.1, a turning area for at least one corresponding transport vehicle 80 can therefore also be provided. The functions to be performed in the respective functional units 11 on individual or multiple objects 30, i.e., in particular handling functions, processing functions, etc., can thus be executed when a corresponding object 30 is moved to or into the housing structure 11.1 of the respective functional unit 11 by means of a corresponding transport vehicle 80. One or more travel paths for transport vehicles 80 extending in different spatial directions can also be implemented within the respective housing structures 11.1.

FIG. 4 shows, by way of example, that the housing structures 11.1 of some functional units 11 may be provided with several access openings 11.4, whereby at least one access opening 11.4 may be configured as an entry opening and at least one access opening 11.4 may be configured as an exit opening; a transport vehicle 80 can, as shown in FIG. 4 by the arrows indicating the exemplary movement paths or trajectories of one or more transport vehicles 80, thus enter the housing structure 11.1 of a functional unit 11 via an entry opening and exit the housing structure 11.1 of the functional unit 11 via an exit opening. As also shown in FIG. 4 as an example for the centrally arranged functional units 11, respective entry and exit openings can be arranged on at least two different, in particular opposite, sides of the housing structure 11.1 of the respective functional unit 11, so that a transport vehicle 80 can enter the housing structure 11.1 of the respective functional unit 11 on a first side and exit the housing structure 11.1 of the functional unit 11 on a second side, thus passing through the functional unit 11. This can enable highly efficient processing of objects 30 in respective functional units 11.

At least one closing member 11.5, such as a door, can be assigned to individual, several, or all access openings 11.4, which, for example, via an assigned actuator device 11.6, can be moved into an open position in which access to the respective housing structure 11.1 is possible, and a closed position, in which access to the respective housing structure 11.1 is not possible. The operation of a respective actuator device 11.6 for moving a respective closing member 11.5 into the open and/or closed position can be carried out via the control 11.7 of the respective functional unit 11 or by the central control device 70. Consequently, the central control device 70 can also be configured to generate control information for controlling the operation of respective actuator devices 11.6 and to transmit this to the respective functional units 11. The operation of the respective actuator devices 11.6 can be controlled in particular on the basis of the orientations and/or positions of at least one transport vehicle 80 detected by means of at least one detection device 90 of the system 10; for example, a closing member 11.5 of an access opening 11.4 can be moved into an open position, for example, when it is detected that a transport vehicle 80 is approaching or has approached the access opening 11.4.

The detection device 90 of the system is configured in particular to detect current and/or future orientations and/or positions of respective transport vehicles 80. The detection device 90 can be used in particular to detect the current and/or future orientation and/or position of respective transport vehicles 80 in the at least one first region B1 of the system 10 and/or in the at least one second region B2 of the system 10 and/or for detecting movements of respective transport vehicles 80 between the at least one first region B1 of the system 10 and the at least one second region B2 of the system 10, or vice versa, configured. The detection device 90 can transmit corresponding detection information describing current and/or future orientations and/or positions of respective transport vehicles 80 to the central control device 70; the central control device 70 can thus communicate with the detection device 90 via a data connection, e.g., a wireless data connection.

The detection device 90 may, for example, be arranged or formed on or in the region of a ceiling of a rack structure of a packaging machine 20 of the system 10. In this way, the detection device 90 can be arranged at a sufficient distance from the transport path TS in order to achieve the largest possible detection range. The detection range of the detection device 90 can, if necessary, cover the entire transport path TS between the or a first B1 and the or a second region B2 of the system 10. Alternatively, or additionally, it is conceivable that several detection devices 90 are provided, whose respective detection areas together cover the entire transport path TS between the or a first region B1 and the or a second region B2 of the system 10. It is generally expedient if the detection device 90 is arranged at an elevation above the respective transport path TS, as this typically allows the detection area to be enlarged.

The detection device 90 may have one or more optical detection elements 90.1 which, for example in the shape of one or more cameras, may be configured as optical sensors, in particular orientation and/or position sensors, or may comprise such sensors. The respective detection elements 90.1 can generate detection information which, for example, describes the orientation and/or position of the respective transport vehicles 80 in space.

The detection information generated by respective detection elements 90.1 can be evaluated by a hardware and/or software-implemented evaluation device (not shown) with regard to at least one evaluation criterion. The evaluation device may be integrated into the central control device 70 in hardware and/or software form. The evaluation device may be configured in particular if the evaluation criterion is, for example, a target orientation and/or target position of a respective transport vehicle 80, to compare an actual orientation and/or actual position of a respective transport vehicle 80 with a target orientation and/or target position of the respective transport vehicle 80 in order to determine any deviations of the transport vehicle 80 from a movement path or trajectory originally specified by the central control device 70. When determining a current and/or future deviation in the manner described above, the central control device 70 can, if necessary, make corrective changes or updates to the movement path or trajectory of the respective transport vehicle 80.

It should be noted at this point that, although these should be configured as simply as possible, transport vehicles 80 may also be equipped with detection sensors (not shown), in particular optical detection sensors, such as a camera. Such detection sensors may be configured in particular to detect patterns, i.e., in particular machine-readable codes such as barcodes, QR codes, etc., arranged or formed on or in a transport path TS, other components of the system 10, such as a frame structure of the system 10, or other transport vehicles 80. This can, for example, provide additional safety to ensure that transport vehicles 80 do not collide.

FIGS. 3 and 4 show examples of various possible arrangements of functional units 11 in an exemplary configuration of the system 10. The functional units 11, which may also be referred to as functional cells, can therefore be arranged or designed, as shown in FIG. 3, e.g., along the transport path TS. Individual, several, or all functional units 11 can therefore be arranged or configured adjacent to the transport path TS, so that, for example, it is possible for objects 30 to be moved via the transport path TS into one or more functional units 11 and/or for objects to be moved from one or more functional units 11 onto the transport path TS, as indicated by the arrows in FIGS. 3 and 4.

In the exemplary embodiment according to FIG. 4, there are functional units 11, which may be, for example, devices for arranging articles or products, possibly packaged in primary packaging, in secondary packaging, or may comprise such devices, between the functional units 11 arranged in the first region B1 and those arranged in the second region B2. The functional units 11 arranged in the first region B1 may, for example, be or comprise devices which are configured to form secondary packaging, e.g., by erecting corresponding blanks. The functional units 11 arranged in the second region B2 can, for example, be or comprise devices that are configured to arrange at least one secondary packaging (together with the primary packaging arranged therein and the article or product arranged therein) in a desired configuration, e.g., stack-like or stack-shaped, with further secondary packagings.

As indicated, the system 10 comprises several transport vehicles 80, each of which has a receiving region 81 for receiving at least one object 30 to be transported (see FIG. 5). A corresponding receiving region 81 can, for example, be formed by a receiving surface, in particular a flat surface, configured to receive at least one object 30 to be transported, or, if necessary, only a single object 30 to be transported. A corresponding receiving surface can, for example, be formed by an exposed wall of a housing structure 80.1 of a respective transport vehicle 80. In particular, as shown in FIG. 5, a corresponding receiving surface can be formed, for example, by an exposed wall of the housing structure 80.1 of a respective transport vehicle 80, which wall forms an upper side of the respective transport vehicle 80. An object 30 received by means of a respective transport vehicle 80 can thus be freely received on the housing structure 80.1 of the transport vehicle 80. The holding of an object 30 can therefore be understood to mean the arrangement or placement of the object 30 on the housing structure 80.1 of a transport vehicle 80.

The transport vehicles 80 are each movable, in particular dependently or independently of one another, between the at least one first region B1 and the at least one second region B2, or vice versa, in at least one translational and/or rotational degree of freedom of movement. In particular, combined movements of respective transport vehicles 80 in at least one translational and at least one rotational degree of freedom of movement are also conceivable, as schematically indicated by the arrows in FIG. 5. The transport vehicles 80 can thus be moved in arbitrarily configurable movement paths or trajectories, so that in principle an infinite number of degrees of freedom of movement are available for the movement of the respective transport vehicles 80.

As mentioned, combined movements of respective transport vehicles 80 in at least one translational and at least one rotational degree of freedom of movement are conceivable. Consequently, respective transport vehicles 80 can change their orientation by rotational movements about a rotation axis indicated in FIG. 5, such as a vertical axis, while they are (simultaneously) moved translationally along a translation axis by translational movements. This makes it possible, for example, for a respective transport vehicle 80 to be loaded with an object 30 in a first orientation in a loading region of the system 10 and for the object 30 to be unloaded from the respective transport vehicle 80 in a second orientation of the respective transport vehicle 80 in an unloading region of the system 10, wherein a transfer of the respective transport vehicle 80 from the first orientation to the second orientation can be performed, for example, during a movement of the respective transport vehicle 80 in the direction of the unloading region of the system 10.

FIG. 5 also schematically illustrates that a respective transport vehicle 80 can be movable in a rotational degree of freedom of movement, whereby it can rotate about a vertical axis at any location. A respective transport vehicle 80 can therefore rotate on the spot without performing a translational movement. This can be particularly advantageous when there is little space available to change the orientation of a respective transport vehicle 80 on the spot. In particular, this can be expedient, for example, in connection with loading and unloading operations when, for example, due to other transport vehicles 80, there is little space available to orient a respective transport vehicle 80 relative to a transfer device 40, 50 or handling device. Similarly, it is possible for a respective transport vehicle 80 to move in any spatial direction from a standing position, i.e., to start moving in any spatial direction from a standing position.

To perform such movements, the transport vehicles 80 each comprise one or more driving devices 80.2 which are configured to generate drive forces or torques which result in a movement of a respective transport vehicle 80 in at least one translational and/or rotational degree of freedom of movement. Corresponding driving devices 80.2 can, for example, be configured as an electric motor or comprise at least one such motor, whose energy supply can be provided via an electrical energy storage device 80.3, such as a rechargeable battery or a battery, a capacitor, etc. Both corresponding driving devices 80.2 and energy storage devices 80.3 can be arranged or configured on or in a housing structure 80.1 of a respective transport vehicle 80, as indicated in FIG. 5.

At least one driving device 80.2 may be assigned a transmission; this may be advantageous, for example, in order to be able to operate the driving device 80.2 in a desired power range. A driving device 80.2 can therefore be coupled directly or indirectly via a gearbox to at least one force transmission element 80.6 of the transport vehicle 80. A corresponding gearbox can also be arranged on or in the housing structure 80.1 of a respective transport vehicle 80.

The movement of the transport vehicles 80 in the respective at least one translational and/or rotational degree of freedom is based on control information which is or will be generated by the aforementioned hardware and/or software-implemented central control device 70 of the system 10. The central control device 70 can include one or more program elements, such as algorithms, calculation models, etc., artificial intelligence or machine learning, such as artificial neural networks, to generate corresponding control information, on the basis of which the transport vehicles 80 can be or are moved in the respective at least one translational and/or rotational degree of freedom of movement along or within the transport path TS or, in general, within the system 10.

The movement of the transport vehicles 80 is therefore controlled centrally via a central control device 79 of the system 10, which is configured to generate control information on the basis of which the transport vehicles 80 can be moved or are moved in the respective at least one translational and/or rotational degree of freedom of movement along or within the transport path Zirkelschenkel or, in general, within the system 10. The central control device 70 is thus not integrated into the transport vehicles 80, but is arranged or configured spatially and physically separate from them, e.g., due to an arrangement on or in a frame structure (not shown) of the system 10. The transport vehicles 80 can therefore be very simply configured with regard to their own control system 80.4 on the transport vehicle side, because the control information on the basis of which the transport vehicles 80 can be moved or are moved in the at least one translational and/or rotational degree of freedom of movement, in particular to move an object 30 from the at least one first region B1 into the at least one second region B2 or in its direction, or vice versa, is generated by the central control device 70 and, as explained below, transmitted to the transport vehicles 80 via a data connection. It is therefore not required for the control system 80.4 of a respective transport vehicle 80 to generate corresponding control information on the basis of which the respective transport vehicle 80 is moved in the at least one translational and/or rotational degree of freedom of movement in order to move an object 30 by means of the respective transport vehicle 80 from the at least one first region B1 into or in the direction of the at least one second region B2, or vice versa. In particular, the respective control 80.4 of the respective transport vehicles 80 can be kept comparatively simple, for example with regard to their hardware and/or software configuration, i.e., in particular their computing and/or storage capacity, which also has a positive effect on the manufacturing costs of the transport vehicles 80.

FIG. 1 shows, representative of the other exemplary embodiments, that the system 10 may comprise at least one loading device assigned to the at least one first region B1, which is configured for the at least partially automated loading of an object 30 to be transported onto a respective receiving region 81 of a transport vehicle 80. The loading device can be formed by or comprise the transfer device 40 or handling device, e.g., a robot. Movements of respective transport vehicles 80 into the first region B1, in order to be loaded there with an object 30 to be transported, are also controlled by the central control device 70; consequently, the central control device 70 is in particular configured to generate control information on the basis of which a respective transport vehicle 80 is moved into the first region B1. The central control device 70 can also be configured to generate control information on the basis of which a respective transport vehicle 80 moves into a specific orientation in the first region B1, e.g. relative to a transfer or handling device located there, for example to enable or facilitate a loading process. Movements of a respective transport vehicle 80 within the first region B1, for example in order to assume a suitable loading orientation and/or position, are therefore typically also performed on the basis of control information generated by the control device 70.

Furthermore, FIG. 1 shows, representative of the other exemplary embodiments, that the system 10 may also comprise at least one unloading device assigned to the at least one second region B2, which is configured for the at least partially automated unloading of an object 30 to be transported from a respective receiving region 81 of a transport vehicle 80. The unloading device may be formed by or comprise a corresponding transfer device 50 or handling device mentioned above, e.g., a robot. Movements of respective transport vehicles 80 into the second region B2, in order to be unloaded there, are also controlled by the central control device 70; consequently, the central control device 70 is in particular configured to generate control information on the basis of which a respective transport vehicle 80 is moved into the second region B2. The central control device 70 can also be configured to generate control information on the basis of which a respective transport vehicle 80 moves into a specific orientation in the second region B2, e.g. relative to a transfer or handling device located there, for example to enable or facilitate an unloading process. Movements of a respective transport vehicle 80 within the second region B2, for example in order to assume a suitable unloading orientation and/or position, therefore typically also take place on the basis of control information generated by the control device 70.

As mentioned, the central control device 70 is implemented in hardware and/or software and thus generally enables computer-implemented generation of corresponding control information and thus computer-implemented simultaneous or at least synchronized control of movements of individual, several or all transport vehicles 80 of the system 10 in respective translational and/or rotational degrees of freedom of movement, in particular to move objects 30 to be transported from the or a first region B1 of the system 10 to the or a second region B2 of the system 10, or vice versa. The generation of corresponding control information and, in particular, the control of the movements of the transport vehicles 80 based on this information can take place in real time.

The system 10 therefore does not require a conveyor belt to implement a transport path TS; rather, the conveyor belt is replaced by the transport vehicles 80. Since the transport vehicles 80 can generally be moved independently or in dependence on one another in respective translational and/or rotational degrees of freedom of movement, and due to the fact that the movements of the transport vehicles 80 are centrally controlled by the central control device 70, a very high degree of flexibility and versatility is possible, for example with regard to the planning, implementation, and control of transport processes. The absence of a conveyor belt also enables completely new system configurations, as the individual components of the system 10, such as corresponding functional units 11, can now be positioned as desired, since they can be reached in any case via corresponding transport vehicles 80.

The system 10 typically comprises a first data transmission device 70.1 assigned to the central control device 70, e.g., formed by or comprising at least one data transmission antenna, which is configured to transmit at least corresponding control information to the respective transport vehicles 80 via a data connection, in particular a wireless data connection. The first data transmission device 70.1 can also be configured to receive data, i.e., for example, to receive data sent by the respective transport vehicles 80, provided that the transport vehicles 80 are configured for this purpose. In order to be able to receive the control information generated by the central control device 70, the transport vehicles 80 each comprise a second data transmission device 80.5, e.g. formed by or comprising at least one data transmission antenna, i.e. in particular at least one data reception device which is configured to receive corresponding control information. A respective second data transmission device 80.5 may also be configured to transmit data to the first data transmission device 70.1. One or more standards or protocols for data transmission, in particular wireless data transmission, can be used to implement a corresponding data connection between the first data transmission device 70.1 and the respective second data transmission devices 80.1 on the transport vehicles, and thus at least to implement the transmission of corresponding control information from the central control device 70 to the respective transport vehicles 80. Possible standards or protocols include, for example, WLAN standards such as IEEE 802.11 standards or mobile communications standards such as 5G. The data connection or data transmission can be encrypted using suitable encryption mechanisms, which may include principles of blockchain technology, in order to prevent unwanted interference or interactions.

The first data transmission device 70.1 can be configured to form a separate plant-side communication network via which data can be transmitted to a communication partner, in particular a respective transport vehicle 80, within the plant 10 or within a component of the plant 10, in particular within a rack structure of the plant 10. The system 10 can thus, by forming its own plant-side communication network, which can in particular be a wireless network, have its own data transmission structure which, in particular because it is separate from other communication networks that may be present in a factory environment, enables a secure(r) data connection between the central control device 70 and respective transport vehicles 80, which in turn can have a positive effect on the control of the movements of the transport vehicles 80 in respective degrees of freedom of movement, as explained, which is carried out or implemented by the central control device 70.

The central control device 70 is configured in particular to generate movement paths or trajectories that can be assigned or are assigned to a respective transport vehicle 80, which are indicated by arrows in FIGS. 1-4, as mentioned. The control information that can be generated or is generated by the central control device 70 can therefore contain, in particular, corresponding movement paths or trajectories. The respective movement paths can in principle be arranged in any path geometry, in particular linear or line-shaped, in one or more, in particular vertical, spatial planes, typically extending between the first and second regions of the system. Linear or curved path geometries can, for example, comprise one or more straight path geometry sections or one or more curved path geometry sections of equal or unequal length, so that corresponding path geometries can be both geometrically defined and geometrically undefined shapes. At least two corresponding path geometry sections may, for example, be oriented at an angle to each other.

Respective movement paths or trajectories can therefore contain or be defined by, in particular, start and end points, i.e., in particular, start and end coordinates, of a movement to be performed by a respective transport vehicle 80, in particular along the transport path TS or within the transport path ZS. Corresponding starting points or coordinates may, for example, be arranged in or in a first region B1 of the system 10, and corresponding end points or coordinates may, for example, be arranged in or in a second region B2 of the system 10.

In addition, respective movement paths or trajectories may include one or more intermediate points or coordinates located between respective starting and end points or starting and end coordinates, so that a respective movement path or trajectory can be described, for example, by corresponding starting, intermediate, and end points or coordinates. Corresponding intermediate points or coordinates can, for example, be assigned to corresponding functional units 11, so that at least one transport vehicle 80 is moved, as part of a movement, e.g., from the first region B1 to the second region B2 of the system 10, e.g., into at least one functional unit 11, in which, for example, at least one of the tasks described above is performed. This is illustrated in FIGS. 3 and 4.

Alternatively or additionally, respective movement paths or trajectories may contain one or more movement vectors arranged between respective start and end points or start and end coordinates, so that a respective movement path or trajectory can be described, for example, by corresponding start and end points or coordinates and corresponding movement vectors. Corresponding movement vectors can also be assigned to corresponding functional units 11, for example, so that at least one transport vehicle 80 is moved within the scope of a movement, e.g., from the first region to the second region of the system, e.g., into at least one functional unit in which, for example, at least one of the tasks described above is performed. This is illustrated in FIGS. 3 and 4.

The central control device 70 can therefore generally be configured to generate at least two movement paths or trajectories that can be assigned or are assigned to transport vehicles 80, which movement paths or trajectories are identical or different. There is therefore a high degree of flexibility and versatility with regard to the planning, implementation, and control of transport operations, since, apart from avoiding collisions between the transport vehicles 80, there are basically no restrictions with regard to the generation of corresponding movement paths or trajectories. The central control device 70 is therefore configured to coordinate the movements of at least two transport vehicles 80, both with identical and with different movement paths or trajectories, i.e., in particular by means of appropriate synchronization, to control them in such a way that there is no risk of collision between the transport vehicles 80. In addition, one or more parameters, such as the loading status of a respective transport vehicle 80 with an object 30, the type of object 30, etc., can be taken into account.

The central control device 70 can therefore be configured to generate first movement paths or trajectories that are assignable to or assigned to a first transport vehicle 80, and to generate further movement paths or trajectories that are assignable to or assigned to at least one further transport vehicle 80. The respective first and further movement paths or trajectories may intersect or not intersect at at least one intersection point, as shown, for example, in FIG. 4; if respective first and further movement paths or trajectories intersect at at least one intersection point, the central control device 70 is configured to coordinate and/or prioritize the movements of the respective transport vehicles 80, i.e., in particular by means of appropriate synchronization, to control them in terms of time so that there is no risk of collision between the respective transport vehicles 80.

In this respect, the central control device 70 may also be configured to assign different priorities to at least two transport vehicles 80. In this way, it may be possible, for example, to easily control which transport vehicle 80 has priority in certain situations, such as a situation at a corresponding intersection of at least two movement paths or trajectories.

The central control device 70 can also be configured to generate at least one movement path or trajectory assigned to a transport vehicle group comprising at least two transport vehicles 80. Consequently, at least two transport vehicles 80 can be combined into a corresponding transport vehicle group, whose movement is based on a common movement path or trajectory. The possibility of combining several transport vehicles 80 into a corresponding transport vehicle group and controlling their movement on the basis of a movement path or trajectory can, if necessary, reduce the computational effort required to control the movements of several transport vehicles 80, as one movement path or trajectory can apply to several transport vehicles 80. In particular, several transport vehicles 80 can move uniformly, e.g., in the direction of the second region B2 of the system 10, based on a corresponding movement path or trajectory, e.g., in a parallel arrangement or in an arrangement offset from each other in at least one spatial axis.

The central control device 70 can also be configured to generate corresponding movement paths or trajectories based on at least one transport criterion relating to the transport of an object 30 by means of a respective transport vehicle 80 and/or at least one object criterion relating to an object 30 to be transported. The central control device 70 can therefore be configured to take into account at least one transport criterion relating to the transport of an object 30 by means of a respective transport vehicle 80 and/or at least one object criterion relating to an object 30 to be transported when generating corresponding movement paths or trajectories.

A corresponding transport criterion may, for example, be or comprise at least one of the following criteria: a safety criterion relating to the safety of the transport operation, e.g. with regard to a collision and/or an undesirable loss of a picked-up object 30, a speed criterion relating to the speed of the transport operation, or a criterion relating to the efficiency of the transport operation, e.g. with regard to the energy consumption of a respective transport vehicle 80 during the transport process, an efficiency criterion relating to the wear and tear of a respective transport vehicle 80 during the transport process.

A corresponding object criterion may, for example, comprise at least one of the following criteria: a type criterion relating to the type of object 30 to be transported, a dimension and/or shape criterion relating to the dimensions and/or shape of the object 30 to be transported, a mass criterion relating to the mass of the object 30 to be transported.

The central control device 70 can also be configured to change at least one movement path or trajectory originally assigned to at least one transport vehicle 80. Control information generated by the central control information and transmitted to the respective transport vehicle 80 may therefore contain corresponding changes to the movement paths or trajectories originally assigned to at least the respective transport vehicle 80 and thus updated movement paths or trajectories for the respective transport vehicle 80. A corresponding change or update to a movement path or trajectory originally assigned to a transport vehicle 80 may be required or expedient, for example, if, due to events or the cessation of events—which can be detected, for example, by the detection device 90 assignable or assigned to the central control device 70—within the transport path TS, an originally assigned movement path or trajectory proves to be no longer executable or expedient. In particular, a corresponding change or update of a movement path or trajectory originally assigned to a transport vehicle 80 may be required or expedient, for example, if an (possible) obstacle, such as contamination, a lost object 30, a defective transport vehicle 80, etc., is detected on the movement path or trajectory, as schematically indicated by a triangle in FIG. 1. (possible) obstacle, such as contamination, a lost object 30, a defective transport vehicle 80, etc., is detected on the movement path or trajectory; the changed or updated movement path or trajectory then enables, for example, the obstacle to be bypassed (as indicated in FIG. 1, for example). Similarly, a corresponding change or update to a movement path or trajectory originally assigned to a transport vehicle 80 may be required or expedient, for example, if, due to the removal of an obstacle, such as contamination, e.g. due to the removal of contamination by means of a cleaning vehicle explained in more detail below, a shorter route and thus, for example, the possibility of more efficient or faster transport of an object 30; the changed or updated movement path or trajectory then enables, for example, a shortened transport and thus typically reduced energy consumption.

Similarly, the central control device 70 can also be configured to change or update a priority originally assigned to a particular transport vehicle 80. The priority of a transport vehicle 80 can be changed, especially during movement toward the second region B2 of the system 10, e.g., from an originally low value to a higher value, or vice versa; This allows, for example, situations to be taken into account in which there is a changed demand for an object 30 transported by a respective transport vehicle 80 in the second region of the system 10. If the demand for a respective object 30 decreases, the priority of the respective transport vehicle 80 can also be reduced and vice versa.

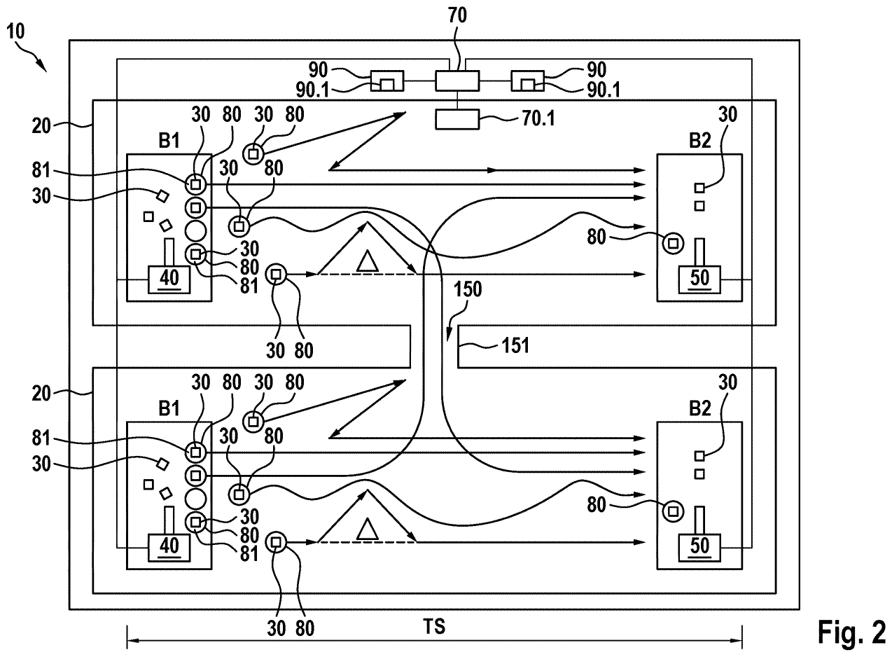

However, other operating modes of the transport vehicles 80, such as a buffer mode, can also be implemented via corresponding modified movement paths or trajectories or prioritizations. If, for example, it becomes apparent that unloading processes are delayed in an unloading region—which can in turn be detected by at least one of the detection devices 90 assignable or assigned to the central control device 70—the movement path or trajectory or priority of at least one transport vehicle 80 loaded with an object 30 can be changed so that it is not moved in the direction of the unloading region, but is moved, for example, to a buffer storage area of the system 10 and/or to a parking area of the system 10. It is also conceivable that, in the event of corresponding delays in the unloading region of a first packaging machine 20, at least one transport vehicle 80 loaded with an object 30 is moved to an unloading region of a second packaging machine 20 on the basis of a correspondingly changed movement path or trajectory or priority, as indicated in the exemplary embodiment according to FIG. 2, which shows a system 10 with several packaging machines 10 and thus several loading and unloading areas.

At least one transport vehicle 80 can therefore also be configured to be moved within the system 10 from a first packaging machine 20 to at least one further packaging machine 20 (see, for example, FIG. 2). The central control device 70 can therefore also be configured to generate movement paths or trajectories extending between at least two packaging machines 20 of the system 10 for at least one transport vehicle 80 and to transmit these to the at least one transport vehicle 80 so that it can be moved between at least two packaging machines 20 of the system 10. This also creates the possibility of dynamically changing the number of transport vehicles 80 available in a respective packaging machine 20 for transporting objects 30, as transport vehicles 80 can be removed from a packaging machine 20 in which, for example with regard to a packaging task, there are too many transport vehicles 80, and can be moved to one or more other packaging machines 20 in which, for example with regard to a packaging task, additional transport vehicles 80 would be required or expedient. This means that dynamic and efficient control options for the operation of a system 10 with several packaging machines 20 are possible.

The same may apply, for example, to functional units 11; the central control device 70 may therefore be configured to generate movement paths or trajectories extending between at least two functional units 11 of a packaging machine 20 or between at least two functional units 11 of several packaging machines 20 for at least one transport vehicle 80 and to transmit them to the at least one transport vehicle 80 so that it can be moved between at least two functional units 11 of a packaging machine 11 or between at least two functional units 11 of several packaging machines 20.

In addition to the possibility of generating movement paths or trajectories and the possibility of changing or updating corresponding movement paths or trajectories, at least one movement parameter of at least one transport vehicle 80, in particular a positive or negative acceleration, a speed, or at least one upper and/or lower threshold value of at least one corresponding movement parameter, can also be controlled via the central control device 70. The central control device 70 can therefore be configured to control at least one movement parameter of at least one transport vehicle 80, in particular a positive or negative acceleration, a speed, or at least one upper and/or lower threshold value of at least one corresponding movement parameter. The central control device 70 can therefore be configured to also generate and control movement profiles of at least one transport vehicle 80.

The central control device 70 may in particular be configured to take into account location and/or time information and/or information derived therefrom, such as current and/or future position information, of a respective transport vehicle 80 when generating corresponding movement profiles. Corresponding movement profiles of a respective transport vehicle 80 may thus contain, for example, location- and/or time-dependent variable movement parameters of at least one respective transport vehicle 80, so that the complete movement sequence of a respective transport vehicle 80 can be controlled via the central control device 70.

When generating corresponding movement profiles, the central control device 70 can therefore be configured to take one or more criteria into account. Alternatively or in addition to corresponding location and/or time criteria, the corresponding criteria can be, for example, the load status of a respective transport vehicle 80, the energy consumption of a respective transport vehicle 80, the state of charge of an electrical energy storage device 80.3 of a respective transport vehicle 80, the condition of a ground U, such as a roadway, on which a respective transport vehicle 80 is moving, etc.

The central control device 70 can also be configured to assign certain movement paths or trajectories and/or certain movement parameters to at least one transport vehicle 80 for certain regions within the system 10. Consequently, the central control device 70 can also be configured to assign specific movement profiles to a respective transport vehicle 80 for specific areas within the system 10, so that a transport vehicle can be moved in a first region of the system 10, for example, at a different speed, in particular a minimum or maximum speed, than in a second region of the system 10.

Corresponding areas of the system 10 can be areas within a packaging machine 20, so that a first region can be, for example, a first section or part of a transport path TS and a second region can be, for example, a second section or part of the transport path TS within a packaging machine 20. Alternatively or additionally, corresponding regions of the system 10 can each be, for example, an (entire) transport path within a specific packaging machine 20, so that a first region can be, for example, a transport path TS within a first packaging machine and a second region can be a transport path TS within a second packaging machine 20 of the system 10.

The central control device 70, as shown schematically in FIG. 6 in a top view, can also be configured to generate control information on the basis of which at least two transport vehicles 80 are moved into a specific formation F, in particular into a specific spatial orientation and/or position relative to each other, or assume such a specific formation F during movement along the transport path TS. By forming corresponding formations F, enlarged loading or unloading areas can be created as required, since the loading or unloading areas of the transport vehicles 80 arranged in a corresponding formation can be added together to form a resulting loading or unloading area. The transport vehicles 80 can therefore be arranged adjacent to one another, e.g., in rows and/or columns, on the basis of corresponding control information generated by the central control device 70, in such a way that their respective loading or unloading areas can be added together or combined to form a resulting loading or unloading area. By determining the number and arrangement or orientation of the respective transport vehicles 80 placed in a corresponding formation F, individually dimensioned loading or unloading areas can be implemented, which also enables the transport of objects 30 that could not be transported with a single transport vehicle 80, e.g., due to their dimensions. In FIG. 6, further transport vehicles 80 are indicated by dashed lines as components of the formation F.

The control information that can be generated or is generated by the central control device 70, on the basis of which at least two transport vehicles 80 can be placed in a specific formation F, in particular into a specific spatial orientation and/or position relative to each other, or to adopt such a specific formation during movement along the transport path TS, can therefore be generated on the basis of at least one transport criterion relating to the transport of an object 30 by means of the respective transport vehicle 80 and/or at least one object criterion relating to an object 30 to be transported. The central control device 70 can therefore be configured to generate corresponding control information based on at least one transport criterion relating to the transport of an object 30 by means of the respective transport vehicle 80 and/or at least one object criterion relating to at least one object 30 to be transported.

A corresponding transport criterion may, for example, be or comprise at least one of the following criteria: a safety criterion relating to the safety of the transport operation, an efficiency criterion relating to the efficiency of the transport operation.

A corresponding object criterion may, for example, be or comprise at least one of the following criteria: type of object 30 to be transported, dimensions and/or shape of object 30 to be transported, mass of object 30 to be transported.

FIG. 6 also indicates that the housing structures 80.1 of the transport vehicles 80 can have a polygonal, for example a quadrangular or hexagonal basic shape. A corresponding polygonal basic shape can enable an (immediately) adjacent arrangement of at least two transport vehicles 80 to form a corresponding formation F, which forms a common, in particular closed, receiving surface for at least one object 30.

FIG. 5 shows a schematic representation of a transport vehicle 80 in a side view. As mentioned, a respective transport vehicle 80 can have a housing structure 80.1. A corresponding receiving region 81, which, as also mentioned, can be in particular a support surface, in particular a flat support surface, is typically arranged or formed on or in the housing structure 80.1. At least one of the following components of the respective transport vehicle 80 is arranged or formed on or in the housing structure 80.1: at least one driving device 80.2 for generating drive forces or moments, at least one energy storage device 80.3 that can be assigned or is assigned to at least one of the at least one driving device 80.2, at least one force transmission element 80.6, such as a wheel, a roller, a chain, etc., via which drive forces or torques generated by the driving device 80.2 can be transmitted to a ground U, a corresponding second data transmission device 80.5, a control 80.4 (on-board control), a detection device, such as a camera, for detecting a ground U or a ground structure on which the respective transport vehicle 80 can be moved or driven. Corresponding components can be arranged or formed, in particular at least in sections, or if necessary completely, within a receiving space defined by one or more walls of the housing structure 80.1, so that they are protected from external influences. The receiving space may have receiving compartments (not shown) formed by one or more wall sections, each receiving compartment being configured to receive at least one component of the respective transport vehicle 80. The dimensions of a respective receiving compartment can thus be selected, for example, with regard to the dimensions of at least one component of the respective transport vehicle 80, so that at least one component can be accommodated in the respective receiving compartment, if necessary with a precise fit, in a loss-proof manner.

Corresponding driving devices 80.2 and force transmission elements 80.6 can form drive units of a respective transport vehicle 80. It is expedient if, when several separate drive units are formed, at least one driving device 80.2 is assigned to each force transmission element 80.6, so that each force transmission element 80.6 can be powered independently of other force transmission elements. In other words, the operation of each drive unit can be controlled individually, so that each force transmission element 80.6 of a drive unit can be set in motion or locked in a specific direction of movement independently of the force transmission elements of other drive units of the respective transport vehicle 80, making it possible, for example, to rotate a respective transport vehicle 80 in place as described.

In a particular embodiment, a respective transport vehicle 80 may comprise three corresponding drive units in a 120° offset arrangement. A respective transport vehicle 80 may thus comprise three drive axes arranged at 120° to each other, each of which has at least one force transmission element 80.6. This not only enables the transport vehicle 80 to rest stably on a ground U, i.e., in particular, to be secured against tipping over, but also allows the described rotational movements of the transport vehicle 80 to be performed on the spot.

Corresponding control commands for controlling the operation of respective drive units of a respective transport vehicle 80 may also be included in the control information transmitted to the respective transport vehicle 80; the central control device 70 may therefore also be configured to control the operation of respective drive units of respective transport vehicles 80. However, it is also conceivable that the control system 80.4 of a respective transport vehicle 80 generates corresponding control commands for controlling the operation of respective drive units on the basis of respective control information transmitted by the central control device 70.

FIG. 7 shows a schematic representation of several transport vehicles 80 coupled to each other to form a transport vehicle arrangement in a side view. FIG. 7 thus schematically shows that at least two transport vehicles 80 can have at least one coupling interface 82, for example a magnetic or mechanical coupling interface, which coupling interfaces 82 are configured to couple the at least two transport vehicles 80 together to form a transport vehicle arrangement, in particular in a detachable manner as required. Consequently, at least two transport vehicles 80 can be coupled to each other to form a transport vehicle arrangement, in particular detachable as required. This can be expedient, for example, in order to move several transport vehicles 80 together. In particular, several transport vehicles 80 coupled to form a transport vehicle arrangement can be moved together, for example, from a first packaging machine 20 to a second packaging machine 20 of the system 10. It may also be expedient to move respective transport vehicle arrangements into a cleaning device 100, a maintenance device 110, or a loading device 120 of the system, etc., which are described in more detail below.

Due to the coupling of the transport vehicles 80, it is fundamentally possible to generate control information for at least one transport vehicle 80 serving as a push and/or pull vehicle (in FIG. 7, this is the right-hand transport vehicle 80) to be generated, since the remaining transport vehicles 80 of the respective transport vehicle arrangement follow the movement path or trajectory of the at least one pushing or pulling vehicle. The central control device 70 can therefore be configured to generate control information on the basis of which at least one transport vehicle 80 of a corresponding transport vehicle arrangement is defined as a push and/or pull vehicle of the transport vehicle arrangement and at least one transport vehicle of the transport vehicle arrangement is defined as a non-push and/or non-pull vehicle, wherein the at least one transport vehicle 80 defined as a push or towing vehicle generates forces or torques by means of which the at least one transport vehicle 80 defined as a non-pushing and/or non-towing vehicle can be moved or is moved, in particular by pushing or pulling forces generated by the pushing or towing vehicle.

A corresponding coupling interface 82 of at least one first transport vehicle 80, shown schematically in FIG. 7, may comprise at least one coupling member 82.1 that can be transferred into a coupling state and into a non-coupled state. The at least one coupling member 82.1 can interact in the coupling state to form a coupling with the coupling interface 82 of at least one other transport vehicle 80, and in the non-coupled state not interact to form a coupling with the coupling interface 82 of at least one other transport vehicle 80. The central control device 70 may be configured to generate coupling information on the basis of which the at least one coupling member 82.1 of at least one transport vehicle 80 can be transferred to the coupling state and/or to the non-coupled state. In this respect, an actuator device (not shown) may be assigned to the at least one coupling member 82.1, which transfers the at least one coupling member 82.1 into the coupling state and/or into the non-coupled state on the basis of corresponding coupling information.

The configuration of the respective transport vehicles 80 can, for example in order to keep manufacturing costs low, be comparatively simple, as they are only configured to transport an object 30, as described, along at least one transport path TS extending between at least a first region B1 of the system 10 and at least a second region B2 of the system 10. A plurality of the transport vehicles 80 of the system 10 can therefore have a minimum configuration comprising at least one corresponding receiving region 81, at least one drive unit, at least one second data transmission device 80.5, and at least one control 80.4, which, as mentioned, can be arranged or formed on or in a corresponding housing structure 80.1.

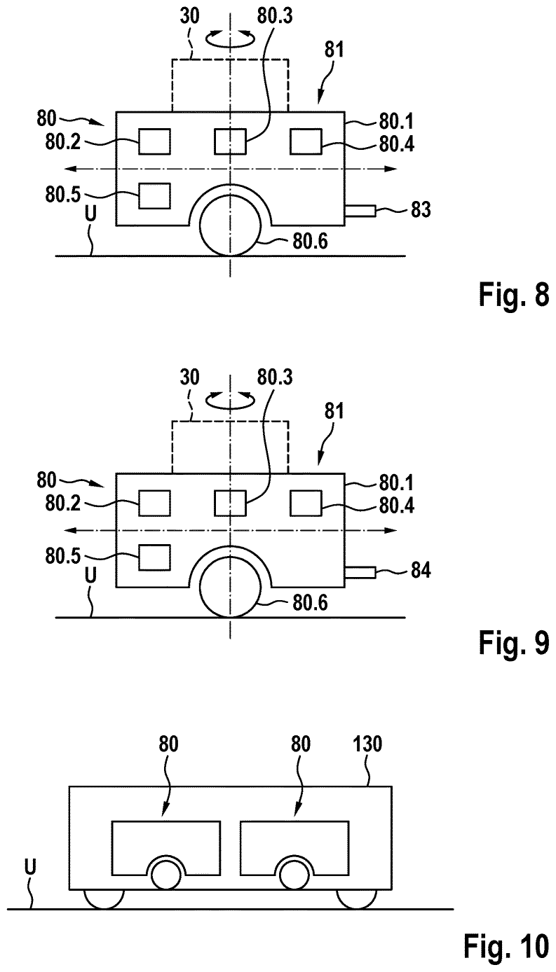

However, it is conceivable that the system 10 has differently or additionally configured transport vehicles 80 with regard to their function, as illustrated by the exemplary embodiments shown in FIGS. 8 and 9:

FIG. 8 shows an exemplary embodiment of a transport vehicle 80 which comprises at least one effector unit 83, i.e., for example, a gripping or suction unit, which is configured to grip an object located on the transport path TS and/or a potential obstacle at least in sections and thus remove it from the transport path TS. A corresponding effector unit 83 can be configured to attach an object located on the transport path TS and/or a potential obstacle to the transport vehicle 80, e.g., by gripping, suction, etc., and thus move it to a region outside the transport path TS. In this way, efficient operation of the system 10 can be ensured because control interventions by the central control device 70 can reduce or prevent collisions between transport vehicles 80 and objects and/or potential obstacles located on the transport path TS. The operation of a correspondingly configured transport vehicle 80 is typically also controlled on the basis of control information generated by the central control device 70.

FIG. 9 shows an exemplary embodiment of a transport vehicle 80 which comprises at least one cleaning unit 84, i.e., for example, a brush, blowing, suction, or rinsing unit, which is configured to clean a driving surface intended for the transport vehicle 80. A corresponding cleaning unit 84 can clean a driving surface, for example, by mechanical cleaning using a brush unit, by blowing away or sucking up contaminants using a blowing or suction unit, or by applying a rinsing or cleaning fluid using a rinsing unit. The operation of a correspondingly configured transport vehicle 80 is typically also controlled on the basis of control information generated by the central control device 70.

As shown schematically in the exemplary embodiment according to FIG. 10, the system may further comprise at least one transfer vehicle 130, which is configured to accommodate several transport vehicles 80 in a receiving region 131 provided for this purpose and to move them collectively within the system 10. This provides an efficient means of moving a plurality of transport vehicles 80 within the system 10, since they can be moved indirectly for this purpose via the at least one transfer vehicle 130, so that the respective transport vehicles 80 do not consume any energy for corresponding transfers within the system 10.

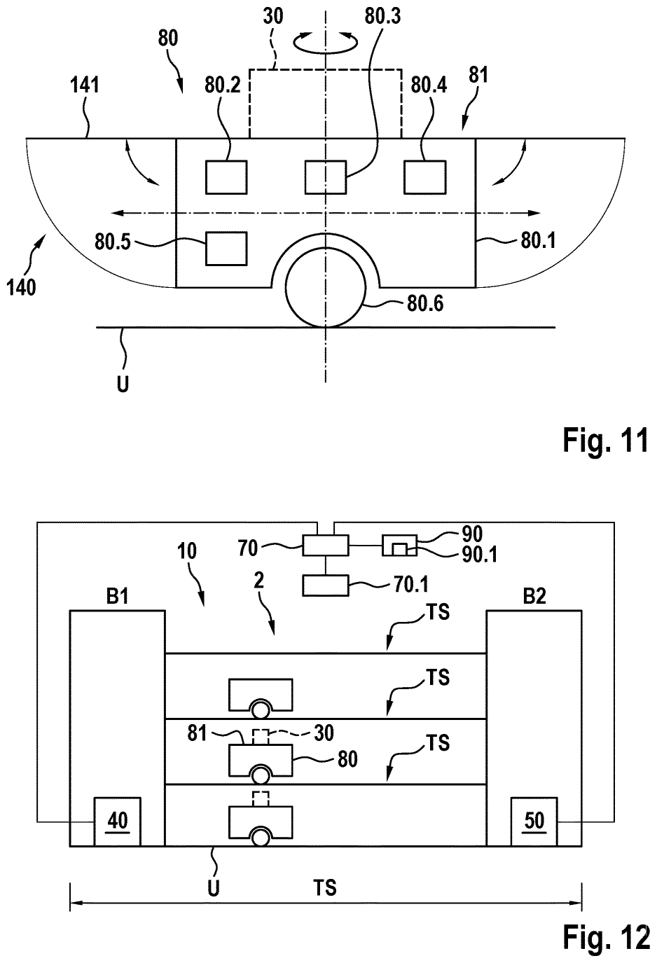

It was mentioned above that at least two transport vehicles 80 can be moved into a formation F in order to create a resulting loading or unloading area. A similar approach to this can be when at least one transport vehicle 80, as schematically shown in the exemplary embodiment according to FIG. 11, has at least one extension structure 140 that extends its receiving region 81, in particular its receiving surface, which can be arranged or is arranged on the at least one transport vehicle 80 via an interface (not shown), e.g., a mechanical interface. By means of the extension structure 140, it is therefore possible to extend the receiving region 81 of a transport vehicle 80 even without forming a corresponding formation F of at least two transport vehicles 80. The extension structure 140 can be arranged or formed on the outer circumference of the housing structure 80.1 of the respective transport vehicle 80 and form an enlarged receiving surface (together) with at least one extension surface element 141 arranged in alignment with the receiving surface of the respective transport vehicle 80.

The extension structure 140 can thus have one or more extension surface elements 141 which, as indicated in FIG. 11 by the double arrows, relative to each other in at least one degree of freedom of movement, so that the extension structure 140 has a first configuration with a first surface area and at least one second configuration different from the first configuration, in which it has a further surface area different from the first surface area, i.e., in particular enlarged or reduced.

Similarly, with particular reference to the exemplary embodiment shown in FIG. 2, it was mentioned that transport vehicles 80 can be moved between at least two packaging machines 20 of the system 10. In this context, FIG. 2 also shows that, for example with regard to safety and control aspects, it may be expedient for a first packaging machine 20 to be connected to at least one further packaging machine 20 via at least one connecting structure 150, in particular a tunnel-like or tunnel-shaped connecting structure. The respective transport vehicles 80 can therefore be moved between the respective packaging machines 20 of the system 10 by means of a corresponding connecting structure 150; since a corresponding connecting structure 150 typically also limits or defines the travel path between the respective packaging machines 20 of the system 10, complex control of the movements of the transport vehicles 80 by the central control device 70 is not required, as the transport vehicles 80 can be guided, for example, by their walls 151 when moving along or through the connecting structure 150.

In all exemplary embodiments, the system 10 may comprise at least one guide device having one or more guide members. The guide device is configured in particular to implement a guided movement of at least one transport vehicle 80 along at least one guide member. Guided movements of respective transport vehicles 80 can reduce the control effort required to implement movements of respective transport vehicles, as at least one movement path or trajectory of corresponding transport vehicles 80 is at least partially predefined by corresponding guide members. A corresponding guide member can, for example, be formed by or comprise a surface element arranged or formed on or within the system 10, in particular in a standing, lying, hanging, etc. position, which has or delimits a surface along which a transport vehicle 80 is guided in a movable manner. Corresponding surface elements can have a one-or multidimensional spatial extension, so that corresponding guide members can be, for example, wall elements, rail elements, pin elements, rod elements, grid elements, fence elements, etc.

In all exemplary embodiments, transport vehicles 80 can be moved not only on flat grounds U, but also on grounds U that are inclined or curved relative to a horizontal reference plane. Consequently, the transport path TS of the system 10 can be arranged within a transport plane that is inclined and/or curved at least in sections.

This also means that the system 10, as shown in the exemplary embodiment in FIG. 12 in a side view, can generally comprise several transport paths TS arranged in different spatial directions and/or spatial planes. In particular, FIG. 12 shows an exemplary stack-like or stack-shaped arrangement of several transport paths TS in several spatial planes one above the other; this can be implemented, for example, by means of a rack structure which enables a stack-like or stack-shaped arrangement of several transport paths TS in several spatial planes one above the other. Corresponding transport paths TS and resulting transport path planes can, for example, be connected to each other via e.g., ramp-like or ramp-shaped connecting sections (not shown) so that a transport vehicle 80 can be moved or driven, for example, from a lower transport path TS via a corresponding connecting section into an upper transport path TS, or vice versa. Similarly, one or more lifting devices (not shown), such as elevators, may be provided, via which one or more transport vehicles 80 can be moved to respective transport route levels. The operation of the respective lifting devices can also be controlled on the basis of control information generated by the central control device 70.

Returning to the exemplary embodiment shown in FIG. 3, it should be mentioned that the system 10 may comprise at least one cleaning device 160, in particular configured as a cleaning station, which is used for the, in particular automatable or automated, cleaning at least one component of respective transport vehicles 80, in particular, for example, wheel-or roller-shaped power transmission elements 80.6 of respective transport vehicles 80. The cleaning device 160 can be a further example of a functional unit 11 of the system into which a respective transport vehicle 80 can be moved on the basis of control information from the central control device 70. The cleaning device 160 can therefore also be arranged, for example, adjacent to a transport path TS. The cleaning device 160 can, analogous to a car wash for motor vehicles, comprise one or more cleaning units or tools 161, e.g., in a housing structure 161 that is accessible at least on one side at least temporarily. 2 of the cleaning device 160, which enable chemical and/or physical cleaning of at least one component of a respective transport vehicle 80. Corresponding cleaning units or tools 161 can also be configured as brush, blow, suction, or rinsing units, for example, or comprise such units.

FIG. 3 also shows that the system 10 can comprise at least one maintenance device 170 configured in particular as a maintenance station, which is configured for the maintenance, in particular automated or automatable maintenance, of at least one component of respective transport vehicles 80. The maintenance device 170 can be a further example of a functional unit 11 of the system 10 into which a respective transport vehicle 80 can be moved on the basis of control information from the central control device 70. The maintenance device 170 can therefore also be arranged, for example, adjacent to a transport path TS. The maintenance device 170 may, analogous to, for example, a workshop for motor vehicles, comprise one or more maintenance units or tools 171, e.g., in a housing structure 171.1 of the maintenance device 170 that is accessible at least on one side at least temporarily, which enable maintenance, i.e., in particular, repair and/or replacement of at least one component of a respective transport vehicle 80. Corresponding maintenance units or tools 171 may, for example, be configured as or comprise screwdriving units, welding units, etc.

Finally, FIG. 3 shows that the system 10 can also comprise at least one charging device 180, configured in particular as a charging station, which is configured for the, in particular contactless, charging of an electrical energy storage device 80.3 of a respective transport vehicle 80. The charging device 180 can be a further example of a functional unit 11 of the system 10 into which a respective transport vehicle 80 can be moved on the basis of control information from the central control device 70. The charging device 180 can therefore also be arranged, for example, adjacent to a transport path TS. The charging device 180 can, analogous to a charging station for electric motor vehicles, comprise one or more charging units 181 or plugs, e.g., in a housing structure 180.1 of the charging device 180 that is accessible at least on one side at least temporarily. It is also conceivable that respective charging units 181 are configured to replace and/or inductively charge a respective energy storage device 80.3; in the latter case, a respective transport vehicle 80 may even be moved during a charging process.

In all cases, the central control device 70 may be configured to generate control information on the basis of which at least one transport vehicle 80 can be moved into the cleaning device 160, the maintenance device 170, and/or the charging device 180. The central control device 170 may also be configured to control and/or monitor the operation of respective cleaning, maintenance, and/or loading devices 160, 170, 180.

In the exemplary embodiments, a respective transport vehicle 80 is an unmanned ground vehicle that can be moved on a floor or ground U. The ground U can be, for example, the floor of a factory hall, so that, although not excluded, it is in principle possible to form at least one corresponding transport path TS (directly) on the hall floor, e.g., of a factory hall, without additional frames, which can considerably simplify the construction of the system 10. In principle, however, it is also conceivable that one, several, or all of the transport vehicles 80 are configured as unmanned aerial vehicles, i.e., in particular as flying drones.

However, a corresponding ground U can also be formed by one or more track elements arranged at least 10 cm, in particular at least 25 cm, and in particular at least 50 cm, above a hall floor. Corresponding roadway elements can be configured as, for example, rack-like or rack-shaped roadway modules, which can be connected to each other to form a roadway for the transport vehicles 80. The roadway elements can each have one or more, for example, mechanical interfaces via which they can be connected to each other. Corresponding roadway elements can also be carriers for one or more data and/or supply lines, e.g., for corresponding functional units 11, meaning that one or more data and/or supply lines, e.g., for corresponding functional units 11, can be arranged or formed on or in a respective roadway element.

It is also conceivable that at least one transport vehicle 80 is configured as an unmanned ground vehicle and at least one further transport vehicle 80 is configured as an unmanned aircraft.

The systems 10 shown in the figures can be used to implement a method for transporting at least one object 30 to be packaged in at least one packaging machine 20 along a transport path TS extending between at least one first region B1 of the system 10 and at least one second region B2 of the system 10.

The method comprises in particular the following steps:
loading at least one transport vehicle, which is movable in at least one translational and/or rotational degree of freedom on the basis of control information generated by the central control device 70 of the respective system 10, between the at least one first region B1 of the respective system 10 and the at least one second region B2 of the respective system 10, or vice versa, on the basis of control information generated by the central control device 70 of the respective system 10, into a transport vehicle 80 movable in at least one translational and/or rotational degree of freedom of movement with at least one object 30 to be transported at or in the first region B1 of the respective system 10 by means of a transfer device configured as a loading device;
controlling at least one movement of the transport vehicle 80 loaded with the at least one object 30 to be transported by means of the central control device 70 to the second region B2 of the respective system 10 along at least one movement path or trajectory defined by the central control device 70; and
unloading the at least one object 30 to be transported at or into the at least one second region B2 of the respective system 10 by means of a transfer device configured as an unloading device.

FIG. 13 shows a schematic representation of a force transmission element 80.6 of a transport vehicle 80 according to an exemplary embodiment. In the exemplary embodiment, the force transmission element 80.6 is configured as or comprises an omnidirectional wheel (omni-wheel). It can be seen that the omnidirectional wheel comprises at least one base structure 80.6.1 that can be driven to rotate about a rotational axis and has a running surface 80.6.2 formed by a plurality of rollers or rollers 80.6.3 whose rotational axes are arranged at right angles to the rotational axis of the base structure 80.6.1. In particular, a configuration with several corresponding base structures 80.6.1 is shown, whose roller or cylinder bodies 80.6.3 are arranged offset from each other in the circumferential direction so that one roller or cylinder body 80.6.3 always contacts a ground.

In all exemplary embodiments, at least one securing device can be assigned to a receiving region 81 of a transport vehicle 80, via which an object 30 to be transported can be secured to the receiving region 81 and thus generally to the transport vehicle 80 as required. A corresponding securing device can be actively executed, i.e., it can be transferred to an active securing state. A corresponding actively configured securing device may, for example, have at least one securing element that can be switched to a securing state, in which it securely engages with a respective object 30, and to a non-securing state, in which it does not securely engage with a respective object 30. A corresponding securing element may be configured as a shape-fit or force-fit element or may comprise at least one such element. A corresponding actively executed securing device may, for example, also be configured as a vacuum device which secures an object in a securing state by applying a vacuum. A corresponding passively executed securing device can, for example, be configured with an adhesion-enhancing surface or surface structure, e.g., in the shape of a rubber coating, of the receiving region 81.

Individual, several, or all of the features described in connection with one exemplary embodiment can be combined with individual, several, or all of the features described in connection with at least one other exemplary embodiment.

Further aspects of the invention are provided in the following clauses:
1. A system for transporting at least one object to be processed, in particular packaged, in at least one packaging machine along or within at least one transport path extending between at least one first region of the system and at least one second region of the system, wherein the system comprises:
a plurality of transport vehicles, each of which is movable between the at least one first region of the system and the at least one second region of the system, or vice versa, on the basis of control information generated by a central control device of the system, in at least one translational and/or rotational degree of freedom of movement, which transport vehicles each comprise a receiving region for receiving at least one object to be transported;
at least one loading device assigned to the at least one first region of the system, which is configured for at least partially automated loading of an object to be transported onto a respective receiving region of a transport vehicle;
at least one unloading device assigned to the at least one second region of the system, which is configured for at least partially automated unloading of a transported object from a respective receiving region of a transport vehicle;
a central control device which is configured to generate control information for controlling the movements of the transport vehicles between the at least one first region of the system and the at least one second region of the system, or vice versa.
2. The system according to clause 1, comprising a first data transmission device assigned to the central control device, which is configured to transmit at least corresponding control information via a data connection, in particular a wireless data connection, to the respective transport vehicles, wherein the respective transport vehicles each comprise a second data transmission device, which is configured to receive corresponding control information.
3. The system according to clause 1 or 2, wherein the first data transmission device is configured to form a separate system-side communication network via which information can be transmitted to a communication partner, in particular a respective transport vehicle, within the system or within a component of the system, in particular within a rack structure of the system.
4. The system according to any one of the preceding clauses, wherein the central control device is configured to generate movement paths or trajectories that can be assigned or are assigned to a respective transport vehicle, and the control information contains corresponding movement paths or trajectories.
5. The system according to any one of the preceding clauses, wherein the central control device is configured to generate movement paths or trajectories assigned to at least two transport vehicles, which movement paths or trajectories are identical or different, wherein the control information contains the movement paths or trajectories assigned to the at least two transport vehicles.
6. The system according to any one of the preceding clauses, wherein the central control device is configured to generate movement paths or trajectories assigned to at least one transport vehicle group comprising at least two transport vehicles, wherein the control information contains the movement paths or trajectories assigned to the at least one transport vehicle group.
7. The system according to any one of clauses 4 to 6, wherein the central control device is configured to generate corresponding movement paths or trajectories based on at least one transport criterion relating to the transport of an object by means of the respective transport vehicle and/or at least one object criterion relating to an object to be transported.
8. The system according to clause 7, wherein the transport criterion is or comprises at least one of the following criteria: a safety criterion relating to the safety of the transport process, a speed criterion relating to the speed of the transport process, an efficiency criterion relating to the efficiency of the transport process; and/or wherein the object criterion is or comprises at least one of the following criteria: type of object to be transported, dimensions and/or shape of the object to be transported, mass of the object to be transported.
9. The system according to any one of clauses 5 to 8, wherein the central control device is configured to change movement paths or trajectories originally assigned to at least one transport vehicle, and the control information contains corresponding changes to the movement paths or trajectories originally assigned to the at least one transport vehicle.
10. The system according to any one of the preceding clauses, wherein the central control device is configured to assign different priorities to at least two transport vehicles and/or to change corresponding priorities.
11. The system according to any one of the preceding clauses, wherein the central control device is configured to control at least one movement parameter of at least one transport vehicle, in particular a positive or negative acceleration, a speed, or at least one upper and/or lower threshold value of at least one corresponding movement parameter.
12. The system according to any one of the preceding clauses, wherein the central control device is configured to assign specific movement paths or trajectories and/or specific movement parameters to at least one transport vehicle for specific regions within the system.
13. The system according to any one of the preceding clauses, wherein the central control device is configured to generate control information on the basis of which at least two transport vehicles are moved into a specific formation, in particular a specific spatial orientation and/or position relative to each other, or assume such a formation during movement along or within the transport path.
14. The system according to clause 13, wherein the central control device is configured to generate the control information on the basis of at least one transport criterion relating to the transport of an object by means of the respective transport vehicle and/or at least one object criterion relating to an object to be transported.
15. The system according to clause 14, wherein the transport criterion is or comprises at least one of the following criteria: a safety criterion relating to the safety of the transport operation, an efficiency criterion relating to the efficiency of the transport operation; and/or wherein the object criterion is or comprises at least one of the following criteria: the type of object to be transported, the dimensions and/or shape of the object to be transported, the mass of the object to be transported.
16. The system according to any one of the preceding clauses, wherein a respective transport vehicle is movable in a rotational degree of freedom of movement, wherein it is rotatable about a vertical axis at any location.
17. The system according to any one of the preceding clauses, wherein a respective transport vehicle has a housing structure on or in which the at least one receiving region is arranged or formed.
18. The system according to any one of the preceding clauses, wherein a respective transport vehicle has a housing structure on or in which at least one of the following components is arranged or formed: at least one driving device for generating drive forces, at least one energy storage device that can be assigned or is assigned to at least one driving device, at least one force transmission element via which drive forces generated by the driving device can be transmitted to a ground, a second data transmission device, a control system.
19. The system according to any one of the preceding clauses, wherein the housing structure has a polygonal, in particular quadrangular, pentagonal, or hexagonal basic shape, which enables an adjacent arrangement of at least two transport vehicles to form a formation that forms a common, in particular closed, receiving surface for at least one object.
20. The system according to any one of the preceding clauses, wherein the housing structure is mounted on a drive axis having two or more, in particular wheel-or roller-shaped, force transmission elements, via which drive forces generated by means of a driving device can be transmitted to a ground.
21. The system according to any one of the preceding clauses, wherein at least two transport vehicles have at least one coupling interface, in particular a magnetic or mechanical coupling interface, which is configured to couple the at least two transport vehicles to each other to form a transport vehicle arrangement.
22. The system according to clause 21, wherein the central control device is configured to generate control information on the basis of which at least one transport vehicle of a corresponding transport vehicle arrangement is defined as a push or pull vehicle of the transport vehicle arrangement and at least one transport vehicle of the transport vehicle arrangement is defined as a non-push or non-pull vehicle, wherein the transport vehicle defined as a push or pull vehicle generates forces by means of which the transport vehicle defined as a non-push or non-pull vehicle is moved.
23. The system according to clause 21 or 22, wherein the coupling interface of at least one first transport vehicle comprises at least one coupling member that can be transferred into a coupling state and into a non-coupled state, which in the coupling state interacts with the coupling interface of at least one other transport vehicle to form a coupling, and in the non-coupled state does not interact with the coupling interface of at least one other transport vehicle to form a coupling, wherein the central control device is configured to generate coupling information that transfers the at least one coupling member into the coupling state and/or into the non-coupled state.
24. The system according to any one of the preceding clauses, wherein at least one transport vehicle comprises at least one gripping unit which is configured to grip an object and/or a potential obstacle located on the transport path.
25. The system according to any one of the preceding clauses, wherein at least one transport vehicle comprises at least one cleaning unit which is configured to clean a driving surface provided for the transport vehicle.
26. The system according to any one of the preceding clauses, comprising at least one transfer vehicle which is configured to accommodate several transport vehicles and to move them collectively within the system.
27. The system according to any one of the preceding clauses, comprising at least one extension structure which extends the receiving region, in particular a receiving surface, of at least one transport vehicle and which can be arranged or is arranged on the at least one transport vehicle via an interface.
28. The system according to clause 27, wherein the extension structure has one or more extension surface elements which are movable relative to each other in at least one degree of freedom of movement, so that the extension structure can be converted into a first configuration having a first surface area and into at least one second configuration different from the first configuration and having a further surface area different from the first surface area.
29. The system according to any one of the preceding clauses, comprising a first packaging machine and at least one further packaging machine, wherein the central control device is configured to generate control information on the basis of which at least one transport vehicle can be moved from the first packaging machine to the at least one further packaging machine, or vice versa.
30. The system according to any one of the preceding clauses, comprising at least one first functional unit and at least one further functional unit, wherein the central control device is configured to generate control information on the basis of which at least one transport vehicle can be moved into the at least one first functional unit, into the at least one further functional unit or from the first functional unit into the at least one further functional unit, or vice versa.
31. The system according to any one of the preceding clauses, wherein the first packaging machine is connected to the at least one further packaging machine via at least one connecting structure, in particular a tunnel-like or tunnel-shaped connecting structure.
32. The system according to any one of the preceding clauses, wherein the transport path is arranged within a transport plane that is inclined and/or curved at least in sections with respect to a horizontal reference plane.
33. The system according to any one of the preceding clauses, further comprising a guide device comprising one or more guide members, which is configured to implement a guided movement of at least one transport vehicle along at least one guide member.
34. The system according to any one of the preceding clauses, wherein the central control device is configured to control the operation of at least one transfer device of the system on the basis of current and/or future alignments and/or positions of respective transport vehicles.
35. The system according to any one of the preceding clauses, comprising a detection device which is configured to detect the orientation and/or position of respective transport vehicles in the at least one first region of the system and/or in the at least one second region of the system and/or to detect movements of respective transport vehicles between the at least one first region and the at least one second region of the system.
36. The system according to clause 35, wherein the at least one detection device is arranged or formed on or in the region of a ceiling of a rack structure of at least one packaging machine of the system.
37. The system according to any one of the preceding clauses, comprising a cleaning device, in particular configured as a cleaning station, for cleaning at least one component of respective transport vehicles, in particular, for example, wheel-or roller-shaped power transmission elements of respective transport vehicles.
38. The system according to any one of the preceding clauses, comprising a maintenance device, in particular configured as a maintenance station, for maintaining at least one component of respective transport vehicles.
39. System according to any one of the preceding clauses, comprising a charging device configured in particular as a charging station for charging, in particular contact-free, an electrical energy storage device of a respective transport vehicle.
40. The system according to any one of clauses 37 to 39, wherein the central control device is configured to generate control information on the basis of which at least one transport vehicle can be moved into the cleaning device and/or into the maintenance device and/or into the charging device.
41. The system according to any one of the preceding clauses, wherein the respective transport vehicles are configured as unmanned ground or air vehicles.
42. A transport vehicle for a system according to any one of the preceding clauses.
43. A method for transporting at least one object to be packaged in at least one packaging machine along or within at least one transport path extending between at least one first region of the system and at least one second region of the system, in particular by means of a system according to any one of clauses 1 to 41, which method comprises the following steps:
loading at least one transport vehicle, which is movable in at least one translational and/or rotational degree of freedom of movement on the basis of control information generated by a central control device of the system, with at least one object to be transported at or in a first region of the system by means of a loading device between the at least one first region of the system and the at least one second region of the system, or vice versa;
controlling a movement of the transport vehicle loaded with the at least one object to be transported by means of the central control device to the second region of the system along at least one movement path or trajectory defined by the central control device;
unloading the at least one object to be transported from the respective transport vehicle in the at least one second region of the system by means of an unloading device.

1. A system for transporting at least one object to be processed in at least one packaging machine along or within at least one transport path extending between at least one first region of the system and at least one second region of the system, wherein the system comprises:
a plurality of transport vehicles, each of which is movable between the at least one first region of the system and the at least one second region of the system, or vice versa, on the basis of control information generated by a central control device of the system, in at least one translational and/or rotational degree of freedom of movement, which transport vehicles each comprise a receiving region for receiving at least one object to be transported;
at least one loading device assigned to the at least one first region of the system, which is configured for at least partially automated loading of an object to be transported onto a respective receiving region of a transport vehicle;
at least one unloading device assigned to the at least one second region of the system, which is configured for at least partially automated unloading of a transported object from a respective receiving region of a transport vehicle; and
a central control device which is configured to generate control information for controlling the movements of the transport vehicles between the at least one first region of the system and the at least one second region of the system, or vice versa.

2. The system according to claim 1, comprising a first data transmission device assigned to the central control device, which is configured to transmit at least corresponding control information via a data connection to the respective transport vehicles, wherein the respective transport vehicles each comprise a second data transmission device, which is configured to receive corresponding control information, wherein the first data transmission device is configured to form a separate system-side communication network via which information can be transmitted to a communication partner within the system or within a component of the system.

3. (canceled)

4. The system according to claim 1, wherein the central control device is configured to generate at least one of,
movement paths or trajectories that can be assigned or are assigned to a respective transport vehicle, and the control information contains corresponding movement paths or trajectories;
movement paths or trajectories assigned to at least two transport vehicles, which movement paths or trajectories are identical of different, wherein the control information contains the movement paths or trajectories assigned to the at least two transport vehicles;
movement paths or trajectories assigned to at least one transport vehicle group comprising at least two transport vehicles, wherein the control information contains the movement paths or trajectories assigned to the at least one transport vehicle group;
corresponding movement paths or trajectories based on at least one transport criterion relating to the transport of an object by means of the respective transport vehicle and/or at least one object criterion relating to an object to be transported, wherein the transport criterion is or comprises at least one of the following criteria; a safety criterion relating to the safety of the transport process, a speed criterion relating to the speed of the transport process, an efficiency criterion relating to the efficiency of the transport process; and/or wherein the object criterion is or comprises at least one of the following criteria type of object to be transported. dimensions and/or shape of the object to be transported, mass of the object to be transported; and/or
wherein the central control device is configured to change movement paths or trajectories originally assigned to at least one transport vehicle, and the control information contains corresponding changes to the movement paths or trajectories originally assigned to the at least one transport vehicle.

5.-9. (canceled)

10. The system according to claim 1, wherein the central control device is configured to assign different priorities to at least two transport vehicles and/or to change corresponding priorities.

11. The system according to claim 1, ok 1, wherein the central control device is configured to:
control at least one movement parameter of at least one transport vehicle; and/or
assign specific movement paths or trajectories and/or specific movement parameters to at least one transport vehicle for specific regions within the system,
generate control information on the basis of which at least two transport vehicles are moved into a specific formation or assume such a formation during movement along or within the transport path on the basis of at least one transport criterion relating to the transport of an object by means of the respective transport vehicle and/or at least one object criterion relating to an object to be transported,
wherein the transport criterion is or comprises at least one of the following criteria a safety criterion relating to the safety of the transport operation, an efficiency criterion relating to the efficiency of the transport operation; and/or wherein the object criterion is or comprises at least one of the following criteria: the type of object to be transported, the dimensions and/or shape of the object to be transported, the mass of the object to be transported.

12.-15. (canceled)

16. The system according to claim 1, wherein a respective transport vehicle is movable in a rotational degree of freedom of movement, wherein it is rotatable about a vertical axis at any location.

17. The system according to claim 1, wherein a respective transport vehicle has a housing structure on or in which the at least one receiving region is arranged or formed; and/or,
wherein a respective transport vehicle bas a housing structure on or in which at least one of the following components is arranged or formed at least one driving device for generating drive forces, at least one energy storage device that can be assigned or is assigned to at least one driving device, at least one force transmission element via which drive forces generated by the driving device can be transmitted to a ground, a second data transmission device, a control system.

18. (canceled)

19. The system according to claim 1, wherein the a housing structure has a polygonal basic shape, which enables an adjacent arrangement of at least two transport vehicles to form a formation that forms a common receiving surface for at least one object.

20. The system according to claim 1, wherein housing structure is mounted on a drive axis having two or more force transmission elements, via which drive forces generated by means of a driving device can be transmitted to a ground.

21. The system according to claim 1, wherein at least two transport vehicles have at least one coupling interface, which is configured to couple the at least two transport vehicles to each other to form a transport vehicle arrangement,
wherein the coupling interface of at least one first transport vehicle comprises at least one coupling member that can be transferred into a coupling state and into a non-coupled state, which in the coupling state interacts with the coupling interface of at least one other transport vehicle to form a coupling and in the non-coupled state does not interact with the coupling interface of at least one other transport vehicle to form a coupling, wherein the central control device is configured to generate coupling information that transfers the at least one coupling member into the coupling state and/or into the non-coupled state;
wherein the central control device is configured to generate control information on the basis of which at least one transport vehicle of a corresponding transport vehicle arrangement is defined as a push or pull vehicle of the transport vehicle arrangement and at least one transport vehicle of the transport vehicle arrangement is defined as a non-push or non-pull vehicle. wherein the transport vehicle defined as a push or pull vehicle generates forces by means of which the transport vehicle defined as a non-push or non-pull vehicle is moved.

22. (canceled)

23. (canceled)

24. The system according to claim 1, wherein at least one transport vehicle comprises at least one of:
at least one gripping unit which is configured to grip an object and/or a potential obstacle located on the transport path;
at least one cleaning unit which is configured to clean a driving surface provided for the transport vehicle.

25. (canceled)

26. The system according to claim 1, comprising at least one transfer vehicle which is configured to accommodate several transport vehicles and to move them collectively within the system.

27. The system according to claim 1, comprising at least one extension structure which extends the receiving region of at least one transport vehicle and which can be arranged or is arranged on the at least one transport vehicle via an interface,
wherein the extension structure has one or more extension surface elements which are movable relative to each other in at least one degree of freedom of movement, so that the extension structure can be converted into a first configuration having a first surface area and into at least one second configuration different from the first configuration and having a further surface area different from the first surface area.

28. (canceled)

29. The system according to claim 1, comprising a first packaging machine and at least one further packaging machine, wherein the central control device is configured to generate control information on the basis of which at least one transport vehicle can be moved from the first packaging machine to the at least one further packaging machine, or vice versa.

30. The system according to claim 1, comprising at least one first functional unit and at least one further functional unit, wherein the central control device is configured to generate control information on the basis of which at least one transport vehicle can be moved into the at least one first functional unit, into the at least one further functional unit or from the first functional unit into the at least one further functional unit, or vice versa.

31. The system according to claim 1, wherein the first packaging machine is connected to the at least one further packaging machine via at least one connecting structure.

32. The system according to claim 1, wherein the transport path is arranged within a transport plane that is inclined and/or curved at least in sections with respect to a horizontal reference plane.

33. The system according to claim 1, further comprising a guide device comprising one or more guide members, which is configured to implement a guided movement of at least one transport vehicle along at least one guide member.

34. The system according to claim 1, wherein the central control device is configured to control the operation of at least one transfer device of the system on the basis of current and/or future alignments and/or positions of respective transport vehicles,
further comprising a detection device which is configured to detect the orientation and/or position of respective transport vehicles in the at least one first region of the system and/or in the at least one second region of the system and/or to detect movements of respective transport vehicles between the at least one first region and the at least one second region of the system,
wherein the at least one detection device is arranged or formed on or in the region of a ceiling of a rack structure of at least one packaging machine of the system.

35.-37. (canceled)

38. The system according to claim 1, further comprising eat least one of:
a cleaning device for cleaning at least one component of respective transport vehicles;
a maintenance device for maintaining at least one component of respective transport vehicles;
a charging device configured for charging an electrical energy storage device of a respective transport vehicle,
wherein the central control device is configured to generate control information on the basis of which at least one transport vehicle can be moved into the cleaning device and/or into the maintenance device and/or into the charging device.

39. (canceled)

40. (canceled)

41. The system according to claim 1, wherein the respective transport vehicles are configured as unmanned ground or air vehicles.

42. (canceled)

43. (canceled)
